(19) United States
(12) Patent Application Publication
(10) Pub. No.: US 2026/0308398 A1
(43) Pub. Date: Oct. 8, 2026

(54) MULTI-JET FUSION PRINTING OF POROUS STRUCTURES

(71) Applicant: Nanyang Technological University, Singapore (SG)

(72) Inventors: Yanbei HOU, Singapore (SG); Ming GAO, Singapore (SG); Kun ZHOU, Singapore (SG)

(21) Appl. No.: 19/423,121

(22) Filed: Dec. 17, 2025

(30) Foreign Application Priority Data
Apr. 7, 2025 (SG) 10202500910V

(51) Int. Cl. C09D 7/62; B29C 64/165; B29C 64/188; B29K 77/00; B33Y 10/00; B33Y 40/20; B33Y 70/10; B33Y 80/00; C09C 1/44; C09C 3/06; C09D 139/06; C09D 177/02

(52) U.S. Cl. CPC C09D 7/62; B29C 64/165; B29C 64/188; B33Y 10/00; B33Y 40/20; B33Y 70/10; B33Y 80/00; C09C 1/44; C09C 3/063; C09D 139/06; C09D 177/02; B29K 2077/00

(57) ABSTRACT

A method includes: selectively depositing a photothermal ink in a powder bed, the powder bed containing a powder mixture, the powder mixture including a polymer powder and a porogen powder; subjecting the powder bed to an infrared radiation to form a composite article; and removing the porogen from the composite article to form a porous article, the porous article having a plurality of pores distributed therein, in which the photothermal ink includes a fusing agent, the photothermal ink being characterized by a photothermal response to the infrared radiation enabling the fusing agent to fuse with the polymer.

### TECHNICAL FIELD

The present disclosure relates to multi-jet fusion printing and more particularly to multi-jet fusion printing of porous structures.

### BACKGROUND

Porous articles have many practical industrial applications. 3D printing can be used to fabricate intricate structures, including regular arrays of structural elements. However, the 3D printing of structural elements that are mutually spaced apart by nano-scale and/or microscale cavities is a challenge.

### SUMMARY

In one aspect, according to various embodiments of the present disclosure, a method includes: selectively depositing a photothermal ink in a powder bed, the powder bed containing a powder mixture, the powder mixture including a polymer powder and a porogen powder; subjecting the powder bed to an infrared radiation to form a composite article; and removing the porogen from the composite article to form a porous article, the porous article having a plurality of pores distributed therein, in which the photothermal ink includes a fusing agent, the photothermal ink being characterized by a photothermal response to the infrared radiation enabling the fusing agent to fuse with the polymer.

In another aspect, an article made according to any of the embodiments described above, in which the plurality of pores are configured to enable capillary action in the plurality of pores.

The article may include: a plate; and a plurality of tree-like structures, the plate, and the plurality of tree-like structures of the porous composite, the plurality of tree-like structures being disposed on the plate.

In yet another aspect, according to various embodiments of the present disclosure, the method includes selectively depositing a photothermal ink in a powder bed, the powder bed containing a powder mixture, the powder mixture including a polymer powder and a porogen powder; subjecting the powder bed to an infrared radiation to form one or more composite articles; and removing the porogen from the one or more composite article to form a corresponding one or more porous article, the one or more porous article having a plurality of pores distributed therein, in which the photothermal ink includes a fusing agent, the photothermal ink being characterized by a photothermal response to the infrared radiation enabling the fusing agent to fuse with the polymer; and in which the one or more porous article forms a solar steam generator, the solar steam generator including: a plate, one or more column, and a plurality of tree-like structures; and in which the one or more column extends from a first side of the plate; and in which the plurality of tree-like structures are disposed on a second side of the plate opposite the first side.

### BRIEF DESCRIPTION OF THE DRAWINGS

To aid understanding, various embodiments of the present disclosure will be described with reference to the following figures:

FIG. 1A (i) and FIG. 1A (ii) are schematic diagrams illustrating a method of making a fusing agent and/or a photothermal ink, according to embodiments of the present disclosure.

FIG. 1B (i) and FIG. 1B (ii) are schematic diagrams illustrating a method of making a porous article by multi-jet fusion (MJF) printing, according to embodiments of the present disclosure.

FIG. 2 shows a finite element model of one “tree-like structure” or one “tree” unit used in the simulation of heat and moisture air transfer. From top to bottom, the finite element model includes three computational domains, namely, a free flow domain, a porous medium domain, and a water domain.

FIG. 3A is a schematic illustration of a transpiration process in plants and of water transport in the trunk/stem and in porous materials.

FIG. 3B (i) is an image of a prototype of a MJF-printed solar steam generator (SSG) and FIG. 3B (ii) schematically illustrates a process of evaporation of water under solar irradiation at the surface of the MJF-printed SSG according to embodiments of the present disclosure.

FIG. 4 shows a schematic fabrication process of a porous SSG via MJF printing (inset a), a TEM image of synthesized MIL-101 (Fe) (inset b), EDS curve (inset c), and a TEM image of C@Fe₃O₄ hybrids (inset d), a survey XPS spectra of MIL-101 (Fe) and C@Fe₃O₄ hybrid (inset e), a schematic illustration of the setup for solar irradiation and temperature recording (inset f), and the photothermal performance of dried HP ink (inset g).

FIG. 5 shows the characterizations of the C@Fe₃O₄ hybrid, in which inset a is a TEM image of C@Fe₃O₄ hybrid, inset b is a HRTEM image of C@Fe₃O₄ hybrid, inset c shows XRD curves of MIL-101 (Fe) and C@Fe₃O₄ hybrid, inset d shows high resolution Fe 2p and C Is spectra and their fitting lines of the C@Fe₃O₄ hybrid, and inset e shows the viscosity of the C@Fe₃O₄-based photothermal ink as a function of shear rate in which the inserted digital image is a printed butterfly pattern via the C@Fe₃O₄ hybrid.

FIG. 6 shows the photothermal performance of MJF-printed SSGs in which inset a shows the heating and cooling behavior of the dried photothermal ink (inserted digital image) under different simulated solar intensities, inset b is a schematic diagram of the photothermal mechanism of the C@Fe₃O₄ hybrid, and inset shows the concentration of iron ions in seawater before and after the samples were immersed for one month.

FIG. 7 shows the characteristics of an exemplary porogen, e.g., sodium carbonate (Na₂CO₃) powder, in which inset a shows SEM images of the Na₂CO₃ powder. The magnified image shows the powder was formed by the stack of Na₂CO₃ crystals. Inset b shows the lateral size distribution of the Na₂CO₃ powder. The peak of gauss fitting line is located at 24.6 μm. Inset c is a digital image captured during the test. The angle between two red lines is avalanche angle. Inset d shows the avalanche angle of the Na₂CO₃ powder. The peak of gauss fitting line is located at 65.3°.

FIG. 8 shows the characterization of MJF-printed SSGs in which inset a is an avalanche angle distribution histogram of Na₂CO₃/PA12 composite powders fitted by Gaussian function, inset b shows the PXRD curves of Na₂CO₃, polyamide 12 (PA12) powder, Na₂CO₃/PA12 powder composite, and printed SSG.

FIG. 9 shows SEM images of fractured surface of porous SSGs made using different formulations: N₂₀/P₈₀ (inset a), N₄₀/P₆₀ (inset b), and N₅₀/P₅₀ (inset c).

FIG. 10 shows porosity control of the MJF-printed SSGs in the form of SEM images of fractured surface of porous N₃₀/P₇₀ under low magnification (inset a) and high magnification (inset b). Inset c shows strain-stress curves of the 3D printed porous materials. 3D micro-CT images of MJF-printed SSG plates of N₂₀/P₈₀ (inset d), N₃₀/P₇₀ (inset e), and N₄₀/P₆₀ (inset f) are shown. Inset g shows a slice of N₃₀/P₇₀ in a horizontal direction.

FIG. 11 shows slices of (inset a) N₂₀/P₈₀ and (inset b) N₄₀/P₆₀ in horizontal direction. Inset c shows the distribution of pore sizes within the slices of the printed samples was quantified utilizing the ImageJ software.

FIG. 12 illustrates water behavior within MJF-printed SSGs. Inset a illustrates water affinity of the MJF-printed SSG plate. Inset b is a schematic illustration of the capillary force-driven water affinity mechanisms in the printed porous SSGs. Inset c illustrates capillary forces facilitating water transport in plants.

FIG. 13 shows water affinity of the MJF-printed SSGs in the form of water contact angle tests of (inset a) dry SSG plate and (inset b) wet SSG plate.

FIG. 14 shows structural features and photothermal performance of tree-structured SSGs, in which inset a are solar reflection and absorption curves of MJF-printed porous SSG and a schematic representation of the absorption mechanism of a porous material, inset b shows a 3D model of the tree-like structure (upper image) and its optical images (lower image), inset c shows the heating behaviors of the tree-structured SSG under various solar irradiation intensities, inset d shows side and top views of the printed tree-like structure obtained via IR camera, inset e shows temperature variations across different locations of tree-structured SSG, and inset f shows the heating behaviors of the tree-structured SSG above water under various solar irradiation intensities.

FIG. 15 shows, at inset a, digital images of SSGs with conical and cylindrical structures, and at inset b, a comparison of the water evaporation performance of SSGs with different surface structures.

FIG. 16 shows, at inset a, the heating behaviors of the as-fabricated SSG plate under various solar irradiation intensities, and at inset b, visualizations of the heat distribution in the SSG plate and in the tree-structured SSG: top view (left) and side view (right) at 5 solar irradiation intensities.

FIG. 17 shows simulation results of cases under 5 sun, including the surface temperature distribution of (inset a) pure water, (inset b) printed tree-structured SSG on water, and (inset c) tree-structured SSG above water, and (inset d) the water distribution in tree-structured SSG above water.

FIG. 18 shows water affinity of the MJF-printed tree-structured SSGs. Water contact angle test of (inset a) dry and (inset b) wet tree-structured SSGs. Inset c illustrates a water climbing mechanism in a tree-structured SSG recorded by a high-speed camera. Upon contact with the water surface, the pre-wetted SSG facilitates a rapid rise of water through capillary forces. Within 0.1 second, water spreads uniformly over the entire SSG, causing the SSG to darken in appearance. Inset d is a schematic illustration of the capillary force-driven water affinity mechanisms in the printed porous SSGs.

FIG. 19 shows the photothermal performance of fabricated polymeric SSGs. Inset a shows visualizations of heat distribution in a SSG plate and a tree-structured SSG: side view (left) and top view (right) at 5 solar irradiation intensities. Also shown are the heating curves of (inset b) water, (inset c) SSG plate placed on water, (inset d) tree-structured SSG placed on water, and (inset e) SSG plate placed above water. “Plate” and “Tree” denote SSG plate and tree-structured SSG, respectively. The impact of solar irradiation intensity on the final temperature of pure water is minimal. The heating rate and final temperature of SSG are influenced by the surface configuration and placement of the SSG.

FIG. 20 shows simulation predictions of surface temperature distribution of printed SSG structures under 5 Sun irradiation, (inset a) SSG plate on water and (inset b) SSG plate above water. The heating curves of tree-structured SSG placed (inset c) on water and (inset d) above water.

FIG. 21 shows the results of a water evaporation test of the MJF-printed SSGs. Inset a shows tree-structured SSG above water during test under 5 sun. Also shown are plots of the weight loss through (inset b) water and (inset c) seawater evaporation under solar illumination as a function of irradiation time. Inset d is a comparison of energy conversion efficiency and evaporation rate between conventional SSGs and the SSG proposed in the present disclosure, tested under 1 solar irradiation intensity. (Inset e) Water and (inset f) seawater evaporation rate of printed SSG samples under different solar irradiation intensities are shown. “Plate” and “Tree” denote SSG plate and tree-structured SSG, respectively. “O,” “A,” “W,” and “SW” mean on, above, water, and seawater, respectively

FIG. 22 shows solar steam generation tests of the MJF-printed SSGs, in which inset a shows a measurement setup of solar steam generation tests. Also shown are the digital and IR images of (inset b) water, (inset c) SSG plate on water, (inset d) tree-structured SSG on water, (inset e) SSG plate above water during test under 5 sun. Inset f illustrates a water evaporation test setup for the MJF-printed SSGs.

FIG. 23 shows the water evaporation performance of fabricated SSGs under different solar irradiation intensities. Water evaporation rate of printed SSG samples under (inset a) 2 sun and (inse b) 5 sun are shown. Seawater evoporation rate of printed SSG samples under (inset c) 2 sun and (inset d) 5 sun are also shown. “Plate” and “Tree” denote SSG plate and tree-structured SSG, respectively. While “O”, “A”, “W”, and “SW” mean on, above, water, and seawater, respectively.

FIG. 24 shows the water evaporation performance of the proposed SSGs under dark conditions. Inset a is an image of the test setup. Inset b shows plots of the weight loss through water evaporation under dark conditions as a function of time.

FIG. 25 shows salt self-cleaning performance (upper images) and corresponding illustrations of the self-cleaning process (lower images) of the SSG plate under 1 solar irradiation intensity with seawater.

FIG. 26 shows salt self-cleaning performance of the SSG plate and the tree-structured SSG under 5 solar irradiation intensities with 25 wt % NaCl solution.

FIG. 27A to FIG. 27D show long-term water evaporation performance of the MJF-printed SSGs. FIG. 27A is an image of a closed container for field-trial testing of the tree-structured SSG. FIG. 27B shows the ion concentrations in seawater and recycled water collected under various solar irradiation intensities. FIG. 27C shows the one-week water evaporation performance of the SSG plate. FIG. 27D shows the one-week water evaporation performance of the tree-structured SSG.

FIG. 28 shows the water evaporation performance test of a large-area SSG. Inset a is an image of a tree-structured SSG printed by commercial printer MJF 5200. Inset b shows the water evaporation test of printed large-area tree-structured SSG under 5 sun for 12 hours.

### DETAILED DESCRIPTION

The following detailed description is made with reference to the accompanying drawings, showing details and embodiments of the present disclosure for the purposes of illustration. Features that are described in the context of an embodiment may correspondingly be applicable to the same or similar features in the other embodiments, even if not explicitly described in these other embodiments. Additions and/or combinations and/or alternatives as described for a feature in the context of an embodiment may correspondingly be applicable to the same or similar feature in the other embodiments.

The word “exemplary” is used herein to mean “serving as an example, instance, or illustration.” Any embodiment described herein as “exemplary” is not necessarily to be construed as preferred or advantageous over other embodiments. As used herein, the singular ‘a’ and ‘an’ may be construed as including the plural “one or more” unless apparent from the context to be otherwise. In the context of various embodiments, the articles “a”, “an” and “the” as used with regard to a feature or element include a reference to one or more of the features or elements.

As used herein, the term “and/or” includes any and all combinations of one or more of the associated listed items. Embodiments described in the context of one of the mixtures are analogously valid for the other mixtures. Similarly, embodiments described in the context of a method are analogously valid for a mixture, and vice versa.

In the context of various embodiments, the term “about” or “approximately” as applied to a numeric value encompasses the exact value and a reasonable variance as generally understood in the relevant technical field, e.g., within 10% of the specified value.

Terms such as “first” and “second” are used in the description and claims only for the sake of brevity and clarity, and do not necessarily imply a priority or order, unless required by the context.

Some methods or processes may be described in terms of steps merely to aid understanding and/or for convenient reference. The delineation between one step and another step may be merely for convenient reference in the present disclosure. It will be understood that in actual implementation there may not be a clear division or transition from one step to another subsequent step. There may be a certain amount of overlap among the steps and/or more than one step may occur or be performed concurrently in time, etc.

Various aspects of MJF printing of porous structures are described in the present disclosure. In the present disclosure, the terms “3D printing” and “additive manufacturing” may be used interchangeably with “multi-jet fusion” (MJF) or “MJF printing”.

### Materials

Embodiments of the photothermal ink proposed herein are particularly suitable for, although not limited to, multi-jet fusion printing methods used in the fabrication of polymer-based articles.

Various polymers have been used in tests and found suitable for the purpose of the present disclosure. Examples of polymers include but are not limited to synthetic polymers, thermoplastics, polylactic acid (PLA), polyethylene terephthalate glycol (PETG), nylon (polyamide), thermoplastic polyurethane (TPU), polyvinyl alcohol (PVA), high impact polystyrene (HIPS), acrylonitrile butadiene styrene (ABS), polypropylene, etc. Various grades of polymers that are commercially available for use in multi-jet printing may be selected for use, for example, various grades of polyamide may be selected, including but not limited to polyamide 12 (PA12), polyamide 11 (PA11), and polyamide 6 (PA6), etc.

According to various embodiments of the present disclosure, a porogen is mixed with the polymer. The porogen is distributed in the polymer before the polymer is cured or hardened into the desired shape. The porogen is removed from the polymer after the polymer is cured or hardened into the desired shape. Porogens suitable for the purpose of the present disclosure include but are not limited to inorganic salts and biomass materials. Examples of porogens tested and found to be suitable include inorganic salts and biomass materials that are soluble in water and resistant to high temperatures (e.g., temperatures at which the polymer is cured or hardened). Examples of suitable inorganic salts include but are not limited to potassium nitrate (KNO₃), potassium sulfate (K₂SO₄), sodium sulfate (Na₂SO₄), calcium chloride (CaCl₂)), sodium carbonate (Na₂CO₃), etc. Examples of suitable biomass materials include but are not limited to glucose, sodium alginate, guar gum, gelatin, chitosan, pectin, etc.

According to various embodiments of the present disclosure, a photothermal ink is added to the polymer and the porogen in the formation of the MJF-printed article. In the context of MJF, the photothermal ink serves as the fusing agent. That is, in the case of MJF, the MJF-printed article is formed of a composite including the polymer and the photothermal ink. To aid understanding, in the case of MJF, the photothermal ink and the detailing agent are not interchangeable with one another, e.g., the detailing agent has to be removed from the workpiece but the photothermal ink is retained as least in part as a part of the composite material forming the MJF-printed article.

According to some embodiments of the present disclosure, the photothermal ink is based on a metal-organic hybrid-based material. For example, the photothermal ink may include water and a quantity of the metal-organic hybrid. For example, the photothermal ink may include water, a surfactant, and one or more metal-organic hybrid materials dispersed in the water. In the present disclosure, for the sake of brevity, the terms “metal-organic hybrid”, “hybrid”, and “metal-organic hybrid material” may be used interchangeably. The suitability of the proposed fusing agent and/or photothermal ink will be described below with reference to experimental data. In general terms, the proposed fusing agent and/or photothermal ink was found to have good photothermal performance, which not only aids in the MJF printing of high-quality products but also shows great promise in enhancing the light absorbance and photothermal conversion efficiency of the final porous article for SSG or other applications.

Examples of the hybrid include derivatives of metal-organic framework (MOF) materials, metal oxide loaded carbon materials, and biomass materials that incorporate metal or metal ions. Examples of MOFs or derivatives of MOFs suitable for the purpose of the present disclosure include but are not limited to ZIFs (Zeolitic imidazolate frameworks), MIL (Material Institute of Lavoisier) MOFs, UiO (University of Oslo) MOFs, HKUST (Hong Kong University of Science and Technology) MOFs, PCNs (porous coordination networks), etc. Examples of metal oxide loaded carbon materials include but are not limited to carbon nanotubes (CNTs), graphene, carbon black, activated carbon, carbon fibers, etc., loaded with metal oxide. Examples of suitable biomass that can serve as a hybrid for the purpose of the present disclosure include but are not limited to melanin, squid ink, polydopamine, etc.

According to some embodiments of the present disclosure, a MIL-101 (Fe)-derived C@Fe₃O₄ hybrid was employed to MJF printing of polymeric porous articles with specific topologies, namely, nano-scale and/or microscale pores or nano-scale and/or microscale channels. The optimized porous structure endows the MJF-printed porous articles with capillary forces, greatly promoting water transport. A tree-like topology was explored and found useful as a SSG to enable high water evaporation rates under various simulated solar radiation conditions. A finite element model was built to fully understand the light-to-thermal energy conversion and water evaporation processes. Advantageously, the MJF-printed porous article could exhibit self-cleaning properties and can automatically remove accumulated salt on its surfaces. During prolonged testing, the water evaporation rate of the SSGs remained relatively stable, i.e., the self-cleaning function enabled the article to retain its porous nature for a relatively long period of time. Used as an SSG, the MJF-printed porous article was found capable of producing desalinated water that met the standards for direct drinking water.

### Multi-Jet Fusion

Some embodiments of the present disclosure will be described below with reference to MJF as an example merely to aid understanding.

MJF is a powder bed fusion additive manufacturing method. The MJF printing process can be generally described in terms of three stages: powder spreading, ink jetting, and powder fusing. A powder spreading stage may include, for example, a layer of powder being spread on a print bed to form a powder bed. An ink jetting stage may include, for example, a fusing agent being ink jetted or otherwise deposited in selected parts of the powder bed. A powder fusing stage may include, for example, providing infrared irradiation, enabling selected regions of the layer of powder to fuse together to form one or more solid parts, etc. The three stages may be repeated to build up a 3D printed article layer-by-layer. As in the case of various powder bed fusion 3D printing, the loose powder in the powder bed may serve to provide support for overhanging structural features. External supports are generally not required for MJF although the use of external supports (if so desired) is not precluded.

The resolution or minimum feature size achievable by conventional MJF is approximately 0.5 mm (millimeter). In other words, in an article made by conventional MJF process, the smallest pore or the smallest hollow space in the article is at least 0.5 mm in diameter. The height to which water can rise in a tube is inversely proportionate to the radius of the tube. For water to rise to a height of about 10 cm (centimeters), a diameter of the tube smaller than 0.3 mm works well. In the present disclosure, for the sake of brevity, a porous article is one that includes holes and/or internal channels with at least some of the holes and/or internal channels being capable of capillary action. For the sake of brevity, a porous article may also be described as one that includes pores or channels of a nanoscale and/or microscale. Internal cavities with such small size in printed porous parts present a challenge when attempting to clean unmelted powder from these surfaces. Consequently, producing capillary structures (e.g., with continuous micrometer-scale pore structure) with MJF printing has conventionally been difficult.

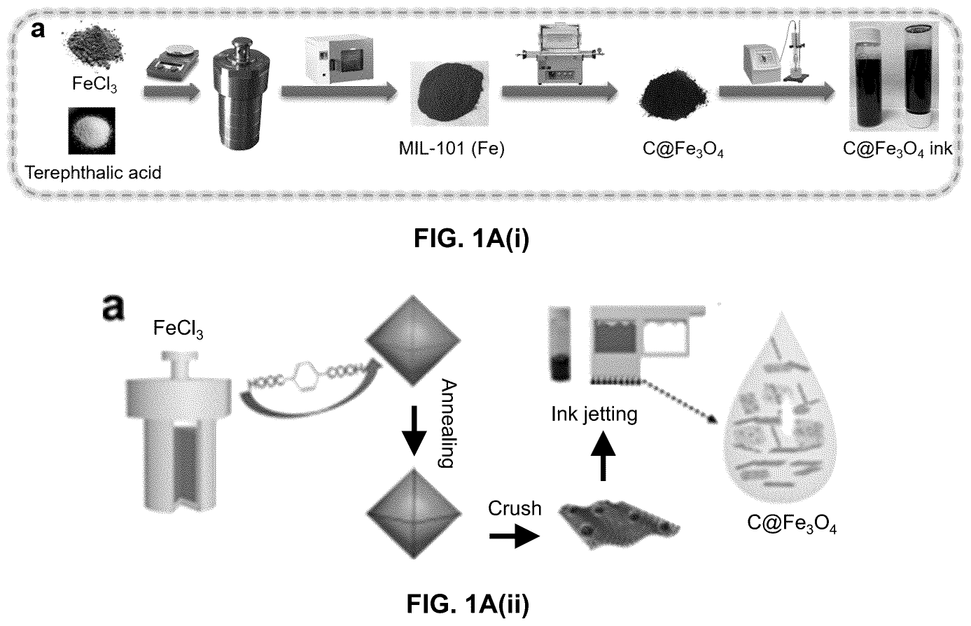

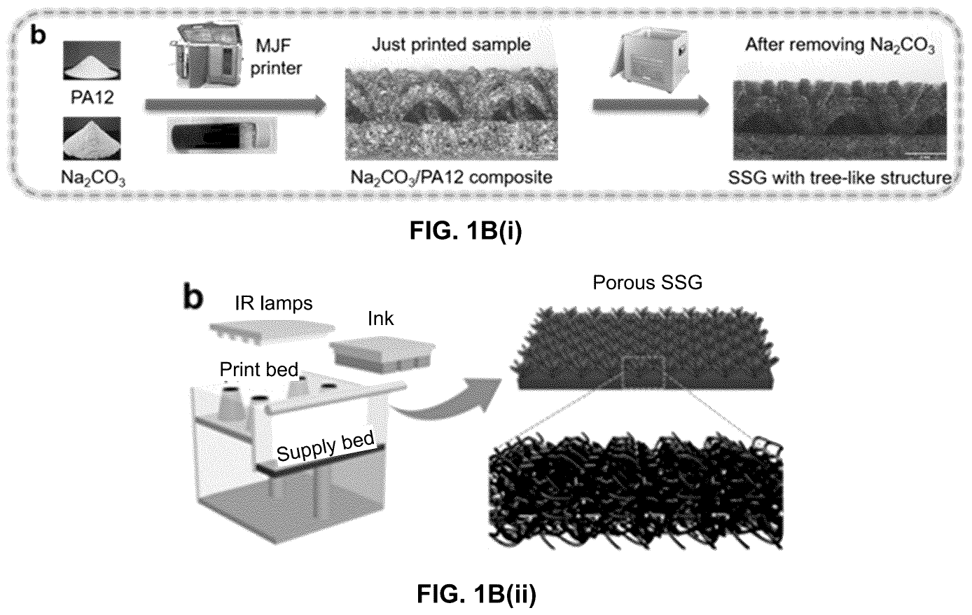

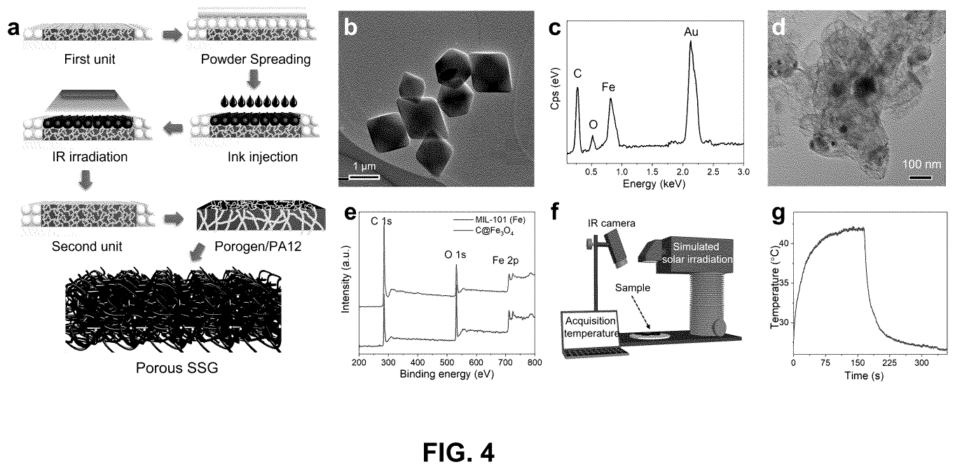

FIG. 1A (i) and FIG. 1A (ii) are flow diagrams schematically illustrating a method of preparing a photothermal ink for MJF-printing of a porous article. The detailed preparation processes of porous SSGs are also shown in FIG. 4 inset a as an example but it will be understood by one of ordinary skill in the art that the method may be used for MJF-printing of other types of porous articles. The photothermal ink includes or serves as a fusing agent in an MJF process. A powder mixture to which the photothermal ink is introduced includes a powder mixture of a polymer powder and a porogen powder. FIG. 1B (i) and FIG. 1B (ii) are diagrams schematically illustrating a method of MJF printing a porous article using an embodiment of the proposed photothermal ink.

### Example I

As shown in FIG. 1A (i) and FIG. 1A (ii), in some examples, a Matérial Institut Lavosier (MIL) metal-organic framework (MOF) material, e.g., MIL-101 (Fe), was synthesized from iron (III) chloride hexahydrate (FeCl₃·6H₂O) and terephthalic acid in a mole ratio of 2:1 in dimethylformamide (DMF) solution. The FeCl₃·6H₂O, terephthalic acid, and DMF solution were purchased from Sigma-Aldrich.

The mixture containing MIL-101 (Fe) was transferred to an autoclave (e.g., a Teflon-lined stainless steel autoclave). In one example, the mixture in the autoclave was heated at 120° C. for 6 hours to form an intermediate mixture having a quantity of a precipitate. The obtained precipitate was collected by centrifugation and annealed at 800° C. in nitrogen for 3 hours. For the annealing process, a heating rate of 5° C. per minute may be used. The resulting black products are hybrids of carbon and iron oxide. In the present disclosure, these hybrids are referred to as C@Fe₃O₄ or as C@Fe₃O₄ hybrids. The term “carbon encapsulated iron oxide” may also be used interchangeably with C@Fe₃O₄.

An amount of the C@Fe₃O₄ hybrids was introduced into a polyvinylpyrrolidone (PVP) solution. In some embodiments, the PVP:C@Fe₃O₄ was in a mass ratio of 1:10. In some embodiments, the C@Fe₃O₄ hybrids were dispersed into a PVP solution of a concentration of 2 milligram per milliliter (mg/ml). The resulting PVP solution was subjected to sonication to better disperse the C@Fe₃O₄ hybrids, e.g., using a probe sonicator operating at 250 Watts for 1.5 hours. Poorly dispersed C@Fe₃O₄ hybrids were removed. For example, deposits of the C@Fe₃O₄ hybrids may be removed by centrifugation at 3000 revolutions per minute (rpm) for 30 minutes.

The resulting liquid includes a well dispersed and black C@Fe₃O₄ hybrid that can serve as the fusing agent in a MJF process, i.e., the resulting liquid can serve as the photothermal ink in a MJF process. The C@Fe₃O₄ hybrid-based photothermal ink includes well-dispersed hybrids in water or in a solution which can facilitate the fabrication of porous PA12-based articles (such as but not limited to solar steam generators (SSGs) via MJF, as schematically illustrated in FIG. 1B (i) and FIG. 1B (ii). For the purpose of illustration, and to aid understanding, a MJF process will be described in further detail.

HP 3D High Reusability PA12 (also referred to herein as “PA12” or “PA12 powder” for the sake of brevity) was available from the HP company. As acquired, the PA12 powder may have a median size of about 52.6 μm (micrometers) and a peak melting temperature of 188.4° C. (degree Celsius).

Sodium carbonate (Na₂CO₃) was mixed with the PA12 powder to form a powder mixture (for the sake of brevity, denoted herein as Na₂CO₃/PA12. The Na₂CO₃ used had a size or a diameter of less than 50 micrometers (μm). Na₂CO₃ may be milled at 300 rpm (revolutions per minute) for 10 minutes and then sieved (e.g., 300-meshed stainless steel sieve) to provide Na₂CO₃ particles within a preferred range of sizes or diameters.

In this example, the powder mixture includes a polymer (e.g., PA12 in a powder form) and a porogen (e.g., Na₂CO₃ in a powder form).

Powder mixtures having various volume ratios of Na₂CO₃ and PA12 may be used. Denoting a volume ratio as Nₓ/P_{y}, where N, P, x, and y denote Na₂CO₃, PA12, a volume of N, and a volume of P, respectively. Preferably, the volume ratio of Na₂CO₃ and PA12 is in a range from 20:80 to 30:70, inclusive of 20:80 and 30:70. Exemplary powder mixtures of Nₓ/P_{y} include 20:80, 30:70, 40:60, etc. These exemplary powder mixtures were verified to have good flowability and are suitable for use in 3D printing.

3D printing parameters or conditions suitable for multi-jet printing (MJP) printing parameters or printing conditions for PA12 may be used for a powder mixture of the PA12 and Na₂CO₃. For example, the MJP printing parameters or MJF printing conditions for a Na₂CO₃/PA12 powder mixture may be selected to be similar to those of MJP printing using pure PA12 powder.

The powder mixture (e.g., Na₂CO₃/PA12 mixture) may be deposited and/or fused into a composite article (also referred to as a workpiece) in a MJF printing process. The Na₂CO₃ may then be removed from the composite article. The resulting article is a porous article.

In greater detail, the Na₂CO₃/PA12 powder mixture may be provided in a layer. For example, the MJF printing apparatus may deposit an amount of the powder mixture in a powder bed (also referred to as the print bed) and/or over a previously printed layer. The deposited powder mixture may be spread out (e.g., using a roller) to form a layer of the powder mixture.

A photothermal ink (e.g., the C@Fe₃O₄ hybrid-based photothermal ink described above) is selectively deposited to the powder bed, i.e., to selected areas of the layer of the powder mixture. In some embodiments, photothermal ink is sprayed on the powder mixture in accordance with a spliced 3D model (also referred to as a “design pattern”). The layer is then subjected to infrared radiation. Heat is absorbed by the C@Fe₃O₄ hybrid or the fusing agent, melting the Na₂CO₃/PA12 powder which then cools or solidifies to form a solid 3D printed part. The photothermal ink is characterized by a photothermal response to the infrared radiation enabling the fusing agent (of the photothermal ink) to fuse with the polymer.

A next layer of the Na₂CO₃/PA12 powder mixture may be provided, followed again by a selective deposition of the fusing agent (e.g., the C@Fe₃O₄ hybrid) in the form of the photothermal ink. Under the irradiation of an infrared lamp, where the fusing agent is present, the polymeric part of the powder mixture will melt to fuse with the fusing agent to form a solid MJF-printed part. The fusing agent serves as a photothermal material by converting the received irradiated energy into heat to melt the neighboring polymeric part of the powder mixture.

The powder mixture is fused under irradiation only where the fusing agent is present. The powder mixture is not fused under irradiation where the fusing agent is absent, i.e., the powder mixture remains in the form of a loose powder throughout and after the powder fusing stage.

In some MJF printing processes, a detailing agent is added to selected parts of the layer of powder mixture. Even under the irradiation of the infrared lamp, where the detailing agent is present, the powder mixture remains as loose powder, i.e., no melting occurs.

In this manner, the workpiece may be built up in layers. At this stage, by stacking layer upon layer, the workpiece is essentially a composite material formed with a unique structure.

After the MJF-printed part (the workpiece or the composite article) has been formed or after the last powder fusing stage, the MJF-printed part (workpiece or the composite article) is removed from the print bed and treated to remove the sodium carbonate particles.

In this example, the Na₂CO₃ may be removed by subjecting the composite article to an ultrasonic water bather, e.g., by immersing the workpiece in a water bath (e.g., of tap water or distilled water) and ultrasonically agitating the water bath for about 30 minutes (e.g., using a sonicator operating at 150 Watts). The workpiece (composite article) may be dried in an oven at 80° C. or about 80° C. After removal of the porogen Na₂CO₃, the article obtained is a porous article formed essentially of PA12 in which the C@Fe₃O₄ is distributed in the PA12 structure.

### Example II

In some other examples, the C@Fe₃O₄ hybrid in Example 1 may be replaced by carbon or carbon-based nanomaterials. For example, the fusing agent may be carbon nanotubes (CNT). In some examples, the porogen may be glucose. Using the MJF printing method described above, a composite article could be formed. Upon removal of the glucose, a porous article was formed.

### Simulation

Solar steam generators are examples of industrially useful articles that can be 3D printed using the 3D printing ink. Simulations were carried out to study heat and moisture air transfer processes of a solar steam generator (SSG) MJF-printed as a porous article using the proposed photothermal ink in place of a conventional MJF fusing agent.

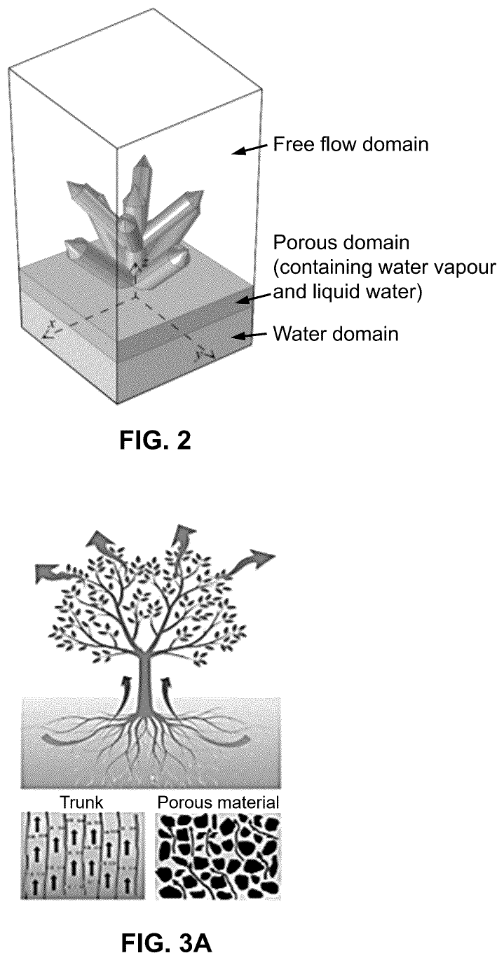

A solar steam generator was simulated by a finite element (FE) model built in a COMSOL Multiphysics software. As shown in FIG. 2, the model was given the same dimensions as one unit of the printed sample. The model defined a porous medium domain, a free flow domain, and a water domain. The model of the SSG included a base (also referred to as a SSG plate). The height of the free flow domain and water domain was 10 times and 2 times the thickness of the porous SSG plate, respectively. The height of the water domain may be set at 0 if the SSG is not in direct contact with the water surface.

The temperature variation was solved by the energy equation in Equation (1) below:

$$ρ {c}_{p} \frac{\partial T}{\partial t} + ρ {c}_{p} u \cdot ∇ T + ∇ \cdot ( - k ∇ T ) = {Q}_{solar} + {Q}_{rad} + {Q}_{evap} + {Q}_{conv} , \qquad ( 1 )$$

where ρ is the material density, cₚ is the heat capacity, and k is the thermal conductivity. The fluid velocity field u in the free flow domain and porous medium domain were solved by the Navier-Stokes equation and the Brinkman equation, respectively. The material properties of the porous medium depend on the concentrations of liquid cₗ and vapor cᵥ which were solved by Fick's first law. As indicated in equation (1), there are four kinds of heat sources in this generator system, including the solar irradiation Qₛₒₗₐᵣ, radiation loss Q_{rad}, heat evaporation Qₑᵥₐₚ and thermal convection Q_{conv}. The expressions of these heat sources are shown in Equation (2) below:

$${Q}_{solar} = α {I}_{solar} \vert \hat{n} \cdot \hat{z} \vert , \qquad ( 2 )$$

$${Q}_{rad} = ε σ ( {T}^{4} - {T}_{0}^{4} ) ,$$

$${Q}_{evap} = {H}_{v} {k}_{v} ( {c}_{sat} - {c}_{v} ) , and$$

$${Q}_{conv} = {h}_{conv} ( T - {T}_{0} ) ,$$

where α is the surface absorptivity, Iₛₒₗₐᵣ is the incident solar intensity, ε is the material emissivity, σ is the Stefan-Boltzmann constant, Hᵥ is the heat of evaporation, kᵥ is the mass transfer coefficient, cₛₐₜ is the saturation vapor concentration, h_{conv} is the convective heat transfer coefficient, and T₀ is the environment temperature.

Data used in this work are listed in Table 1.

TABLE 1

| Parameters | Values |
|---|---|
| Environment temperature T₀ | 300.15K |
| Freestream velocity u₀ | 1 m · s⁻¹ |
| Molecular weight of air Mₐ | 0.028 kg · mol⁻¹ |
| Air viscosity | 1.81 × 10⁻⁵ kg · m⁻¹ · s⁻¹ |
| Air thermal conductivity kₐ | 0.025 W · m⁻¹ · K⁻¹ |
| Air heat capacity cₚₐ | 1.006 × 10³ J · kg⁻¹ · K⁻¹ |
| Air density ρₐ | 1.205 kg · m⁻³ |
| Molecular weight of liquid M₁ | 0.018 kg · mol⁻¹ |
| viscosity of water μ₁ | 1.002 × 10⁻³ kg · m⁻¹ · s⁻¹ |
| thermal conductivity of water k₁ | 0.59 W · m⁻¹ · K⁻¹ |
| heat capacity of water cₚₗ | 4.182 × 10³ J · kg⁻¹ · K⁻¹ |
| density of water ρₗ | 998.2 kg · m⁻³ |
| vapor viscosity μᵥ | 1.8 × 10⁻⁵ kg · m⁻¹ · s⁻¹ |
| vapor thermal conductivity kᵥ | 0.026 W · m⁻¹ · K⁻¹ |
| vapor heat capacity cₚᵥ | 2.062 × 10³ J · kg⁻¹ · K⁻¹ |
| Porosity εₚ | 0.37 |
| Permeability κ | 1 × 10⁻¹⁴ m² |
| Porous matrix thermal conductivity kₚ | 0.25 W · m⁻¹ · K⁻¹ |
| Porous matrix heat capacity cₚₚ | 17004 J · kg⁻¹ · K⁻¹ |
| Porous matrix density ρₚ | 1010 kg · m⁻³ |
| Surface absorptivity α | 0.96 |
| Incident solar intensity Iₛₒₗₐᵣ | |
| | 1000 W · m⁻² |
| Material emissivity ε | 0.96 |
| Latent heat of evaporation Hᵥ | |
| | 2.256 × 10⁶ J · kg⁻¹ |
| Mass transfer coefficient kᵥ | 1000 kg · mol⁻¹ · s⁻¹ |
| Convective heat transfer coefficient h_{conv} | 10 W · m⁻² · K⁻¹ |

Five moduli of COMSOL were generated together to simulate the above-mentioned equations. Specifically, the fluid heat transfer module was employed to simulate Equation (2), while Qₛₒₗₐᵣ and Q_{rad} were coupled to Equation (2) by applying the surface-to-surface radiation module. The fluid velocity field was solved within the laminar flow module, and the transfer of liquid water and moist vapor in porous medium domain were determined by two dilute species transport moduli. In the current simulation, the calculation domain was segmented into 30917 tetrahedral meshes with a maximum size of 0.0219 mm. The employed time step was 0.025 min. The applied computational domain, mesh size, and time step were configured for both numerical accuracy and computational efficiency.

### Characterization

The viscosity of the photothermal ink can affect the ability of the MJF printing process or the MJF printing apparatus to accurately deposit the photothermal ink. For example, a certain level of viscosity is required to provide a sufficiently strong binding force to fuse powder particles together. The flowability of the 3D printing ink can also affect the uniformity and consistency of the powder bed. Poor flowability might result in an uneven powder bed or non-uniformity in terms of the spread of powder (powder spread) and powder particle sizes across the powder bed. Good flowability generally enables good spreadability of the powder.

To assess the viscosity or flowability of the proposed photothermal ink, XRD patterns were recorded on Shimadzu 6000 x-ray diffractometer with Cu Kα radiation (1=0.154 nm) to investigate the crystalline structures of the materials used in the photothermal ink. The powder sample was flattened in the designed holder and placed horizontally on the test bench. Transmission electron microscopy (TEM, JEM-2100F, Japan Electron Optics Laboratory Co., Ltd., Japan) was employed to investigate the micromorphology of MOF and the C@Fe₃O₄ hybrids. To confirm the elementary composition of C@Fe₃O₄, x-ray photoelectron spectroscopy (XPS) was applied on the samples with a VG ESCALB MK-II Electron spectrometer (A1 Kα excitation source at 1486.6 eV, Japan). The morphology of the fillers and fracture surfaces of the printed samples was characterized using a scanning electron microscope (SEM) (JSM-5600 LV, JEOL, Japan). The flowability of the Na₂CO₃/PA12 powder mixture was investigated by a flowability measurement instrument (Revolution Powder Analyzer, Basel, Switzerland) before it was used for printing. The avalanche angle was measured 250 times, and the rotation rate of the drum was 0.6 rpm (revolutions per minute). The mechanical properties of the printed samples were characterized by the Shimadzu AGX 10 kN universal tester at a crosshead speed of 10 mm min⁻¹ (millimeter per minute). Five samples (ASTM D638 Type V standard) were measured for each group. The apparent viscosity of the fusing agents was measured at a shear rate ramp from 0.1 to 100 s⁻¹ by a rotational rheometer (DHR-2, TA Instruments, USA) with a parallel plate geometry of 40 mm diameter. The temperature distribution of the powder bed and printed parts was recorded using an infrared camera (A655sc, FLIR systems, Inc., USA)

### Prototypes

It was experimentally verified that the photothermal ink may be used in combination with a porogen-polymer mixture to fabricate a MJF-printed article in which the article is characterized by a porous structure. The porous structure may be described as a three-dimensional network of continuous or interconnecting pores or cavities. The porous structure may also be referred to as a capillary structure in that the continuous pores can generate the required surface tension force to promote a flow of water in the continuous pores, including an upward flow of water or a flow of water against the effect of gravity.

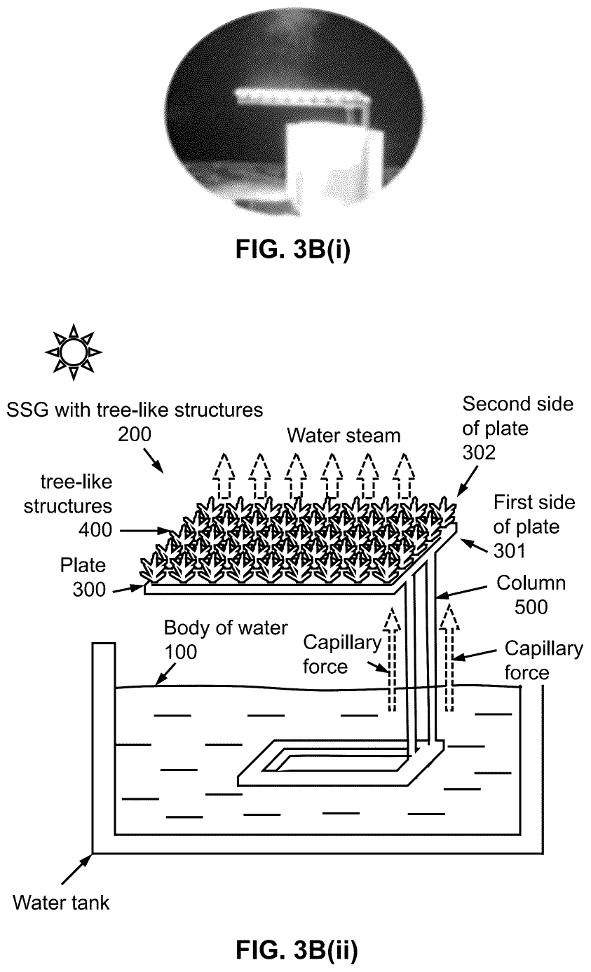

The MJF-printed porous article made according to embodiments of the present disclosure includes a presence of continuous micrometer-scale pores. In the prototypes fabricated, it was observed that the MJF-printed porous article was capable of capillary action, i.e., capillary forces that facilitate water transport in plants (e.g., as schematically illustrated in FIG. 3A). The proposed article includes porous-MJF-printed parts that can promote water transport from a container of water to one or more surfaces of the MJF-printed parts.

It was found that the proposed photothermal ink and resulting MJF-printed articles could be highly suitable for making solar steam generators (SSGs), e.g., devices to enable seawater desalination in natural environments. SSGs were fabricated as described above and tested using experimental setups such as one as shown in FIG. 3B (i). FIG. 3B (ii) is a schematic drawing to better show various aspects of the proposed SSG. Each SSG 200 may be entirely MJF-printed to have a tree array structure (a plurality of tree-like structures 400) disposed on a plate 300. The SSG may be supported by least one column 500 extending from a first side 301 of the plate. The plurality of tree-like structures may form a canopy (e.g., a canopy-like structure or a plurality of branching structures) at a second side 302 the plate 300, with the canopy spaced apart from the plate. The first side 301 and the second side 302 may be opposing sides of the plate 300. The SSG may include one or more porous columns 500 to support the SSG 200 and to draw water (e.g., by capillary forces) away from a body of water 100 (or the water surface of the water tank). The one or more columns 500 help to prevent direct contact between the SSG 200 and water surface, thereby reducing the propagation of heat toward the body of water 100 and facilitating heat accumulation on the one or more surfaces of the SSG 200. The capillary structure or porous matrix throughout the SSG 200, further aided by the tree-like configuration of the SSG 200, as well as the spaced apart arrangement of the plate 300 from the body of water 100, were found to reduce thermal losses and improve the efficiency of water evaporation.

### Characterization of Photothermal Ink

Samples of MIL-101 (Fe) were prepared by reacting FeCl₃·6H₂O and 1,4-dicarboxybenzene as precursors.

The resulting transmission electron microscopy (TEM) image of the MIL-101 (Fe) samples as shown in FIG. 4 (inset b) revealed the formation of octahedral-shaped MIL-101 (Fe) crystals with sizes around 2 μm. The crystals exhibited a concave surface and confirmed the successful synthesis of the MOF.

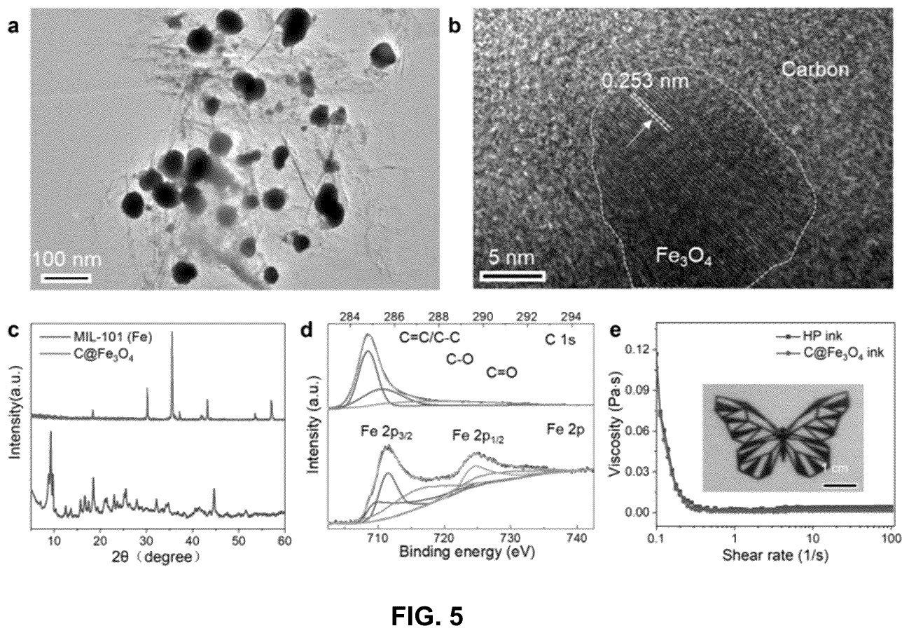

As described above, a one-step-controlled calcination method was utilized to prepare the C@Fe₃O₄ hybrids. Owing to the collapse of the crystal structure of the synthesized MOF, a morphologically aggressive transformation of MIL-101 (Fe) was observed after the pyrolysis process. Energy-dispersive spectrometry (EDS) as shown in FIG. 4 (inset c) indicated that the sample was mainly composed of C, O, and Fe. The TEM image shown in FIG. 5 (inset a) displays the presence of opaque matrices (amorphous carbon) wrapped with black spots (magnetic Fe₃O₄ nanoparticles with an average diameter of around 50 nm). This constitution was confirmed by the enlarged TEM image shown in FIG. 4 (inset d), suggesting that Fe₃O₄ nanoparticles were embedded in the amorphous carbon. A high-resolution TEM (HRTEM) image, as shown in FIG. 5 (inset b) provides further insight into the structural information on the building blocks. The HRTEM image clearly shows the lattice fringe with an interplanar spacing of 0.253 nm, assigning to the (311) crystal plane of Fe₃O₄.

FIG. 5 (inset c) shows three characteristic powder x-ray diffraction (PXRD) peaks at 2θ=8.7°, 19.7°, and 22.5°, which confirm the formation of MIL-101 (Fe). After annealing at 900° C. for 3 hours, the original diffraction peaks were no longer observed, indicating a transformation of the crystalline structure into a new phase. The XRD peaks were located at 18.2, 30.2, 35.5, 43.3, 53.2, and 56.7, corresponding to (111) (220) (311) (400) (422), and (511) reflections of the cubic spinel structure, in accordance with the TEM results. These peaks are consistent with the major peaks of Fe₃O₄ indicating that the Fe₃O₄ crystal structure resulted from the pyrolysis of MIL-101 (Fe) to form a C@Fe₃O₄ hybrid.

The full x-ray photoelectron spectroscopy (XPS) spectra of the MIL-101 (Fe) and C@Fe₃O₄ nanomaterials are shown in FIG. 4 (inset e). The degradation of organic parts in MOFs increased the mass ratio of Fe-containing compounds, as demonstrated by the increased atomic content of Fe from 5.89% for MIL-101 (Fe) to 10.13% for C@Fe₃O₄. FIG. FIG. 5 (inset d) presents the narrow scan XPS spectra of C Is and Fe 2p in C@Fe₃O₄ hybrids. The C Is spectrum can be deconvoluted into three components C═C/C—C(284.7 eV), C—O (286.1 eV), and C—O (288.9 eV), confirming the high content of C═C/C—C carbon, which benefits the light absorption. The fitted peaks at 710.0 eV and 726.3 eV correspond to Fe 2p_{3/2} and Fe 2p_{1/2} of Fe³⁺, while the fitted peaks at 708.6 eV and 724.1 eV correspond to Fe 2p_{3/2} and Fe 2p_{1/2} of Fe²⁺, respectively, confirming the existence of Fe₃O₄ in the hybrids. By utilizing XRD, XPS, and TEM, it was demonstrated that the one-step-controlled calcination is a viable method for converting MIL-101 (Fe) precursors into C@Fe₃O₄ hybrids.

### Printability

The viscosity of the photothermal ink and the flowability of the powder are factors of interest as they affect the MJF printability of the formulations. The C@Fe₃O₄ hybrid-based photothermal ink has a viscosity similar to that of a fusing agent (FA), available from the HP company, as indicated by the comparable concentrations (see, e.g., FIG. 5 inset e). The value of the inverse Ohnesorge number Z is used to evaluate the photothermal ink droplet jetting behaviors and can be calculated by Equation (3):

$$Z = \sqrt{ρ γ d} / η \qquad ( 3 )$$

where ρ, γ, and η denote the density, surface tension, and complex viscosity (at 100 s⁻¹) of the C@Fe₃O₄ hybrid-based photothermal ink, respectively. The ρ values of the FA and the synthesized C@Fe₃O₄ hybrid-based photothermal ink were 1.105 g·cm⁻³ and 1.125 g·cm⁻³, respectively. The y values of the C@Fe₃O₄ hybrid-based photothermal ink and the FA were determined as 43.6 mN·m⁻¹ and 31.6 mN·m⁻¹, respectively, using a contact angle meter. Based on the above-mentioned data, the Z value of the FA and the C@Fe₃O₄ hybrid-based photothermal ink can be calculated to be 7.959 and 3.173, respectively, within the range from 1 to 10, demonstrating that the photothermal ink droplet jetting will be stable.

After being filled with the C@Fe₃O₄ hybrid-based photothermal ink, the printer ink cartridges were mounted on the MJF testbed for printing tests. As shown in FIG. 5 (inset e), the C@Fe₃O₄ hybrid-based photothermal ink can be used in place of the FA. The C@Fe₃O₄ hybrid-based photothermal ink is capable of printing the designed pattern with a resolution (of the pattern) that can be as fine as smaller than 200 μm. This shows that the prepared photothermal ink has good printability.

### Photothermal Properties

The photothermal properties of the photothermal ink were also investigated in the context of MJF. A preferred fusing agent has good heat absorption performance, e.g., in terms of reducing the intensity required of the infrared light during MJF printing and in terms of the photothermal performance of the -MJF-printed products (e.g., SSGs).

In the experiments, the simulated solar irradiation device was a Xenon light source (HF-GHX-XE-300, Hefan, China). Temperature of the sample was detected and recorded by an infrared camera (FLIR A6000, Teledyne Technologies, U.S.) as shown in the set-up of FIG. 4 (inset f).

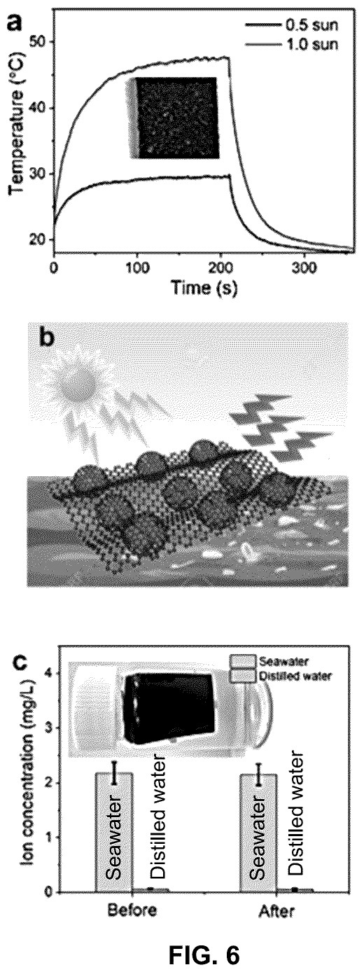

FIG. 6 (inset a) shows the photothermal performance of a MJF-printed plate of PA12 (“a first PA12 plate”), using the C@Fe₃O₄ hybrid of the proposed photothermal ink as a fusing agent. The first PA12 plate was exposed to different irradiation intensities. The temperature of the PA12 plate could reach 47.3° C. in 100 seconds under one simulated solar irradiation (1 sun). In contrast, the corresponding temperature of a second PA12 plate of similar physical dimensions and 3D printed without the C@Fe₃O₄ hybrid of the proposed photothermal ink as a fusing agent (e.g., using a conventional fusing agent) could only reach 42.1° C., as shown in FIG. 4 (inset g), confirming the superior photothermal performance of the C@Fe₃O₄ hybrid.

Additionally, after the irradiation is turned off, the temperature decay profile of the first PA12 plate and the second PA12 plate, e.g., FIG. 6 (inset a), indicated that the C@Fe₃O₄ hybrid has a slower cooling rate, which can be advantageous in maintaining the temperature of printed SSGs.

In the C@Fe₃O₄, the carbon coating on the surface of the Fe₃O₄ nanoparticles enhances their photothermal properties, leading to improved photothermal conversion efficiency, as illustrated in FIG. 6 (inset b). The C@Fe₃O₄ hybrid can efficiently absorb near-infrared light and convert it into heat, due to the combined effects of the carbon shell and Fe₃O₄ core. In addition, Fe₃O₄ has excellent stability and low toxicity, making it a safer option for water treatment applications compared to conventional photothermal agents. The carbon shell also provides a protective barrier, shielding the iron oxide core from degradation, oxidation, and other unwanted reactions. The use of a stable filler can reduce the adverse impact of SSGs on water safety.

To investigate the stability of the MJF-printed porous SSGs, MJF-printed porous SSGs were immersed in both seawater and de-ionized water, respectively. After being placed outdoors for one month, the concentration of Fe³⁺ ions in the liquids were monitored. As shown in the inserted graph (FIG. 6 inset c), no black precipitate was observed in the seawater, and the Fe³⁺ ion concentration in both seawater and de-ionized water before and after immersion remained almost unchanged. This suggests that the prepared C@Fe₃O₄ hybrid can be safely utilized as a photothermal ink for MJF printing of polymeric SSGs for seawater desalination and water evaporation, without posing any potential hazards from the raw materials.

### Characterization of MJF-Printed Samples

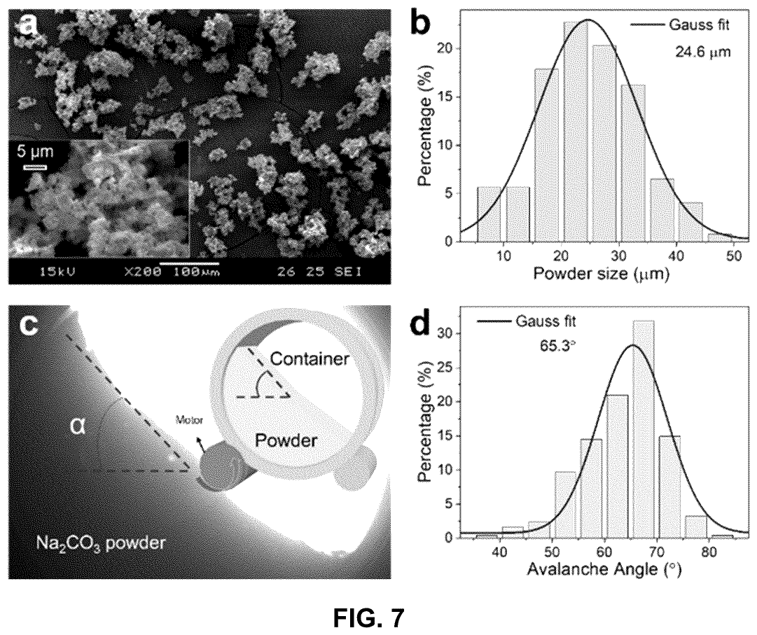

The PA12 powder used in this work had a median size of 52.6 μm and a peak melting temperature of 188.4° C. The average size of milled Na₂CO₃ powder was 24.6 μm (FIG. 7 inset a and FIG. 7 inset b).

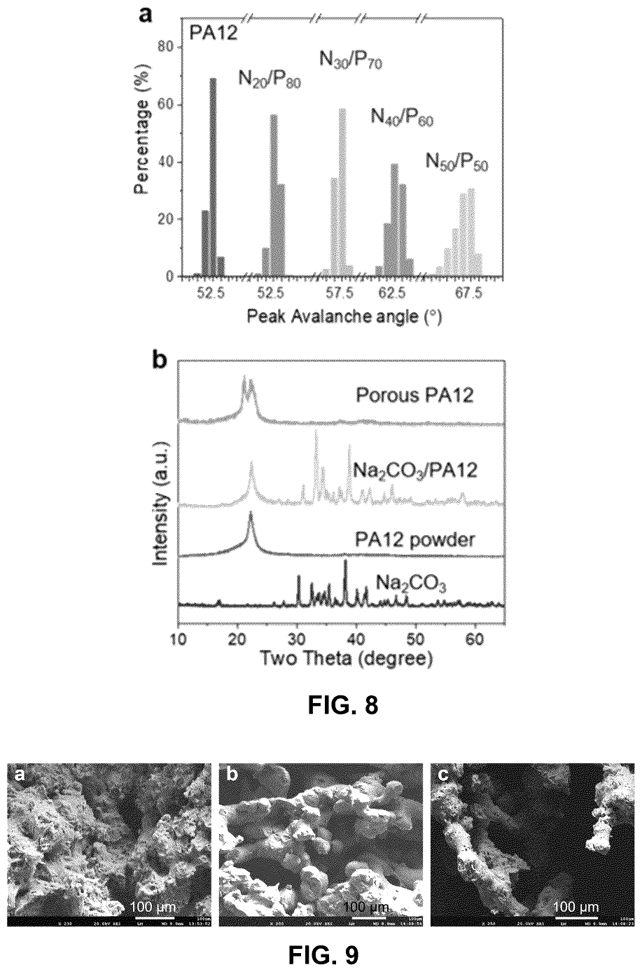

The effect of powder formulation on its flowability can be characterized by an avalanche angle tester. When the powder in the container rotates with the motor, it will produce a collapse angle, that is, an avalanche angle. The larger the value of the avalanche angle α, the worse the fluidity of the powder, as shown in FIG. 7 (inset c). FIG. 8 (inset a) shows that the flowability of composite powders deteriorates with the increase in Na₂CO₃ content. The peak value of a increased from 52.5° (degrees) for pure PA12 to 67.5° for N₅₀/P₅₀. The avalanche angle of Na₂CO₃ was 65.3°, much higher than that of pure PA12 powder, e.g., FIG. 7 inset d.

The small Na₂CO₃ particles can fill the voids between PA12 powder particles. The composite powders or the powder mixtures can be more dense and more compact, compared to a similar volume of only one constituent of the powder mixture. In the present disclosure, preferred formulations include N₂₀/P₈₀ and N₃₀/P₇₀.

### Porosity

XRD, scanning electron microscope (SEM), and micro-computed tomography (Micro-CT) were used to verify the porosity of the MJF-printed parts made with different volume ratios of Na₂CO₃.

For a MJF-printed article made from a N₃₀/P₇₀ formulation, Na₂CO₃ could be easily removed by subjecting the MJF-printed article to ultrasonication at 150 W for 30 minutes. After the ultrasonication, as shown in FIG. 8 (inset b), the sharp peaks of Na₂CO₃ are absent from the XRD curve of MJF-printed article, suggesting that the article is a porous article formed essentially of PA12.

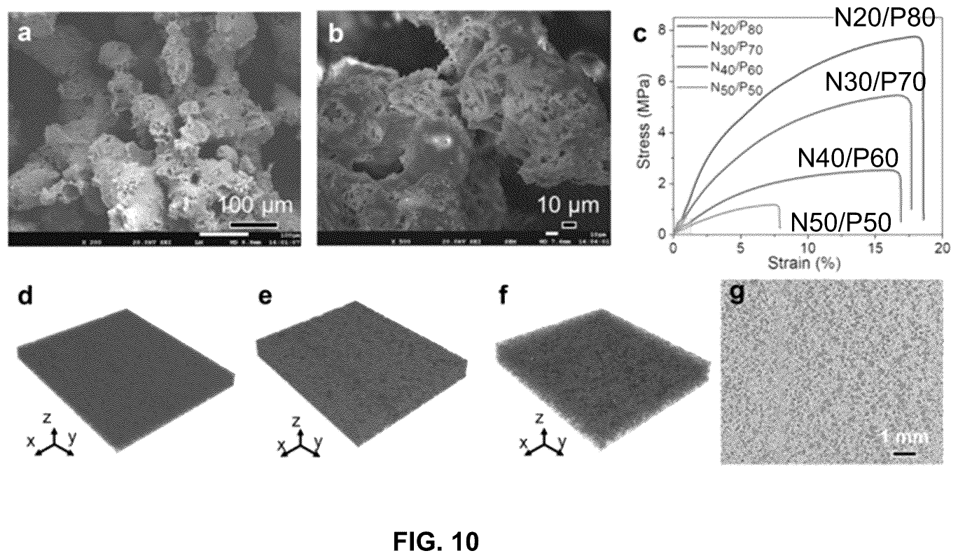

SEM images of fractured surfaces of the MJF-printed articles are shown in FIG. 9. In the case of the MJF-printed article made using N₂₀/P₈₀, FIG. 9 (inset a) shows some small and island-like holes, indicating no continuous holes formed in this formulation. Continuous holes were observed in N₃₀/P₇₀ (FIG. 10, inset a and inset b), N₄₀/P₆₀ (FIG. 9, inset b), and N₅₀/P₅₀ (FIG. 9, inset c). The porogen to polymer ratio may thus be selected to obtain different types of porous structures. For the purpose of MJF printing of SSGs, N₃₀/P₇₀ may be selected to form micro-scale pores that enable efficient fluid transport while maintaining structural integrity with a relatively good mechanical strength. The fusing agent of this composition was also found to have a relatively good powder flowability for MJF printing. The N₂₀/P₈₀ composition was found to be an operable choice after N₃₀/P₇₀.

The structural elements of the MJF-printed porous articles (“skeletons”) are thinner with a decreasing volume ratio of PA12. It is conventionally expected that the mechanical strength of a 3D printed article would be compromised or impaired, e.g., conventional thinking would believe that voids existing inside a material would inevitably deteriorate the mechanical properties. The voids in the material of the 3D printed article may act as force concentration sites, weakening the ability of the 3D printed article to resist external forces.

It was therefore a surprising outcome when the porous MJF-printed articles were found to satisfy the strength criteria of SSGs, i.e., exhibit satisfactory mechanical properties of even at high porosity levels (>30%). As shown in FIG. 10 (inset c) and Table 2, the tensile strength of porous 3D printed articles (in these examples, SSGs) decreased with the increasing porosity, that is, from 7.75 MPa (megapascals) for N₂₀/P₈₀, to 1.16 MPa for N₅₀/P₅₀. The N₃₀/P₇₀ porous 3D printed article was significantly stronger than the N₄₀/P₆₀ porous 3D printed article and can find many practical applications.

TABLE 2
The mechanical properties of porous PA12 with different porosity.

| | | Tensile | Young's | |
|---|---|---|---|---|
| | Porosity | strength | modulus | Elongation |
| Sample | (%) | (MPa) | (GPa) | (%) |
| N₂₀/P₈₀ | 25 | 7.46 ± 0.29 | 0.93 ± 0.23 | 18.6 ± 3.1 |
| N₃₀/P₇₀ | 37 | 5.44 ± 0.26 | 0.93 ± 0.23 | 17.7 ± 2.8 |
| N₄₀/P₆₀ | 51 | 2.53 ± 0.47 | 0.60 ± 0.01 | 11.9 ± 4.3 |
| N₅₀/P₅₀ | — | 0.93 ± 0.23 | 0.03 ± 0.01 | 5.6 ± 2.6 |

The microscopic difference in the structure directly affects the mechanical properties of the MJF-printed part. The inner holes of the MJF-printed parts were detected by Micro-CT, and the combined three-dimensional constructions are portrayed in FIG. 10, insets d to f. The transparency of the constructions increases with the content of porogen (Na₂CO₃), indicating the increasing porosity. The porosity of N₂₀/P₈₀, N₃₀/P₇₀, and N₄₀/P₆₀ can be obtained by processing computed tomography (CT) slices with the software ImageJ, which were 25%, 37%, and 51%, respectively. A horizontal slice of N₂₀/P₈₀ (as shown in FIG. 10, inset g) confirmed the island-like structure of holes.

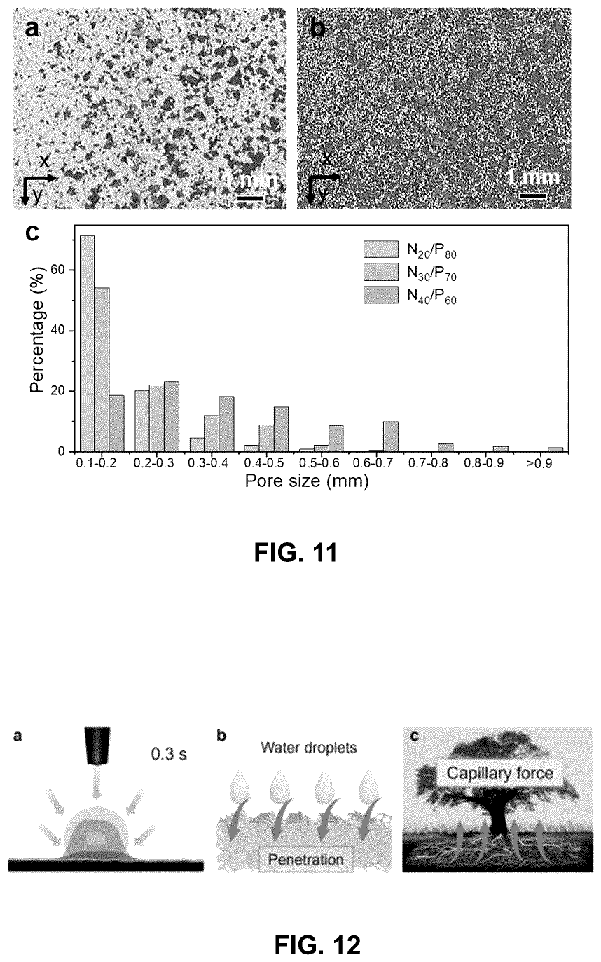

Micro-scale pores of a relatively uniform size can be observed in horizontal sections of N₃₀/P₇₀, which allows for efficient transport of fluids while preventing unwanted materials from passing through (FIG. 10, inset g). Small holes scattered in the full view of the slice for N₄₀/P₆₀ and separated the PA12 skeletons (FIG. 11 inset b), leading to a weaker mechanical performance.

The results above confirmed the porous nature or the presence of continuous pore structures in the MJF-printed articles.

The distribution of pore sizes within the slices of the 3D printed samples was quantified utilizing the ImageJ software. The related results are shown in FIG. 11 (inset c). As the concentration of Na₂CO₃ increases, the pore size distribution within the 3D printed articles shifts toward larger dimensions, which may contribute to a deterioration of the mechanical properties of the MJF-printed articles. In some cases, even though the Na₂CO₃ particles were mixed with PA12 particles through mechanical mixer, some particles may have flowed together with the melted polymers and, thus, generated holes larger than their original size.

### Capillary Action

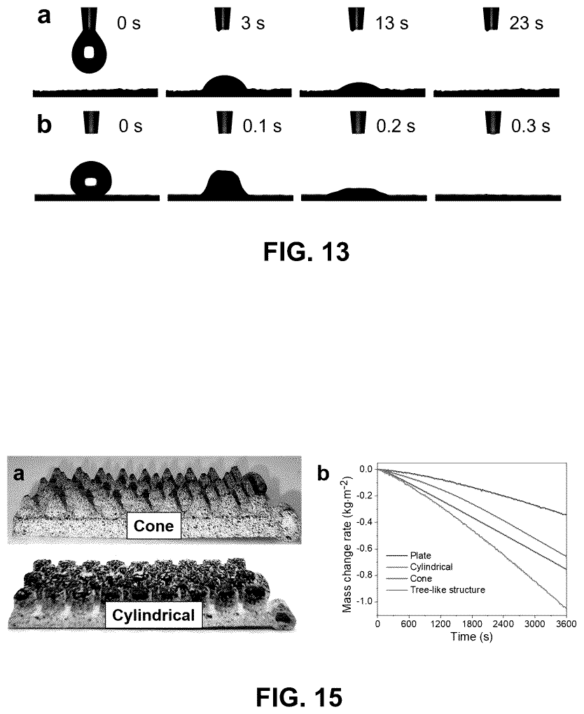

The water contact test results shown in FIG. 12 (inset a) and FIG. 13 (inset a) clearly illustrate the excellent water affinity of the MJF-printed article made according to embodiments of the present disclosure. SSGs fabricated as proposed in the present disclosure were shown to have a water affinity that is advantageous for the desired water transport in the SSGs for desalination. The high porosity and interconnected porous structure of the MJF-printed article resulted in sufficiently large capillary forces that facilitate water penetration, endowing the MJF-printed article with good hydrophilic properties. It was observed that water droplets could easily permeate from a surface of the SSGs to the interior of the SSGs. When the interior of the SSGs is wetted, the capillary action became more pronounced, and water droplets penetrated the interior in a very short time (less than 0.3 seconds). This result is indicative of a significant improvement in hydrophilicity over conventional SSGs.

Similar to the way in which trees and grasses absorb water via capillary forces (schematically illustrated in FIG. 12, inset b and inset c), the rapid water absorption property of the SSGs was able to facilitate the drawing of seawater from a location of a lower elevation to a location of higher elevation. Heat conduction is reduced as there is minimal direct contact between the SSG and the seawater. This property allows for a substantial portion of the available photothermal energy to be utilized for seawater evaporation on the surfaces of SSGs. The proposed MJF-printed porous article was shown to be capable of desalination efficiency of SSGs.

### Structural Configuration

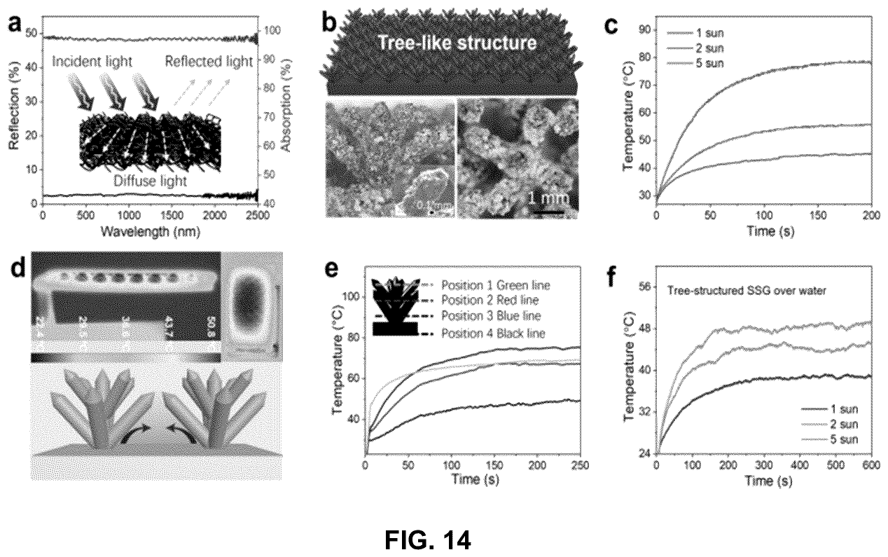

To determine the optical properties of the proposed MJF-printed porous articles, prototypes of SSGs were fabricated as disclosed herein and test for the reflection spectra and the transmission spectra. The spectra of the prototypes (2×2×0.05 cm²) were measured using an ultraviolet-visible-near-infrared spectrophotometer. The results, as shown in FIG. 14 (inset a), indicate that the MJF-printed porous article had a very low reflectance of less than 3.5% and almost no transmission in the range of 250 nm to 2500 nm, which covers most of the solar spectrum. These findings suggest that the MJF-printed porous article has the capacity to absorb a broad range of light, up to 96.7% of the incident solar energy. The rough surface architecture, porous structure, and the presence of C@Fe₃O₄ contribute to multi-scattering and light trapping effects that increase the optical path length of the incident light. As a result, solar energy conversion efficiency can be enhanced.

Various three-dimensional structures (cone, cylindrical, and tree-like structure) were designed using computer-aided drawing (CAD) and fabricated upon a PA12 plate to investigate their steam generating capabilities (FIG. 15 inset a and FIG. 14 inset b) for increased surface areas to promote the generation of interfacial solar steam. The various structures, including the tree array structure, may be manufactured using MJF as described above.

The comparison on water evaporation performance of SSGs demonstrates that among these designs, the tree array structure, which includes multiple layers of branched smaller cones on a larger conical trunk, showed good performance (FIG. 15 inset b). The optical microscope images show a tree-like structure with dimensions of approximately 16 mm² in area, 3 mm in height, and a base diameter of approximately 0.8 mm.

In one example, the tree array structure includes a plurality of tree-like structures distributed across a MJF-printed porous plate of the same material. For example, the tree array structure may be MJF-printed as an integral article with each tree-like structure forming a contiguous extension from a first side or a first major surface of the 3D printed porous plate. A second side or a second major surface (opposing the first side or the first major surface) of the MJF-printed porous plate may be free of tree-like structures. One or more columns may extend from the second side of the MJF-printed porous plate. The one or more columns may be similarly MJF-printed as the porous plate and the tree-like structures. The one or more columns may be disposed partially in a body of water (e.g., seawater) such that capillary action draws water from the body of water along the column to the plurality of tree-like structures. In this manner, the porous plate and the tree-like structure may be disposed spaced apart from the body of water.

In one example, each tree-like structure (each SSG) includes eight branches extending from a trunk near the bottom and halfway up the trunk. Each branch extends from the trunk at an inclination of about 45° relative to trunk. The trunk and the branches each may end in a conical tip. The minimum size of the conical tip may be approximately 200 μm. Collectively, the plurality of tree-like structures (supported or disposed on the MJF-printed porous plate) form a tree array structure with interstitial spaces between the branches and the trucks. In the present disclosure, the material of the porous article (i.e., the material obtained after removal of the porogen) is also referred to as a “porous matrix”. The porous matrix is beneficial for achieving effective water transport within the entire MJF-printed porous article.

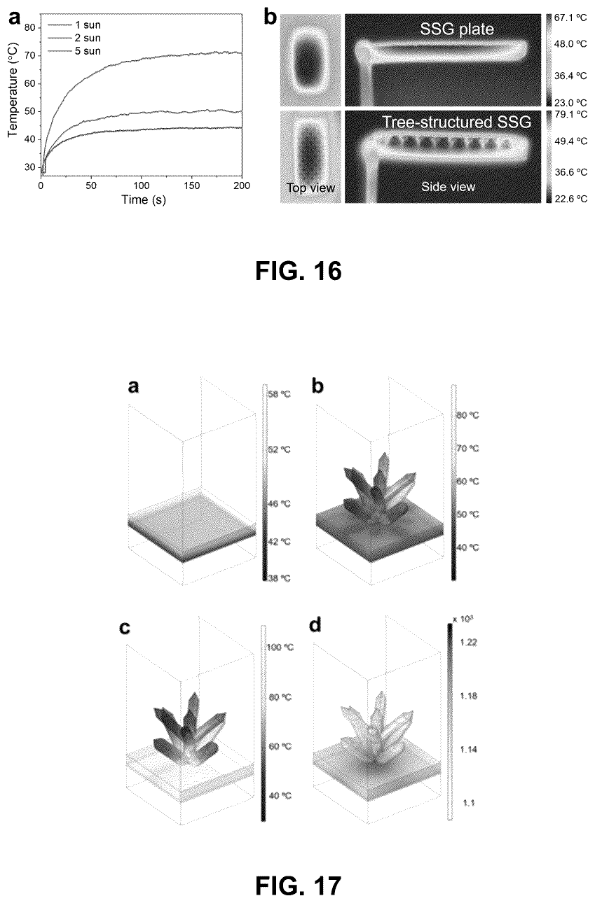

The temperature-time curve in FIG. 16 (inset a) shows the increase in the temperature of the MJF-printed porous plate under different irradiation intensities. As the light intensity increased, the stable temperature also increased. The MJF-printed porous plate could reach a temperature of 44.03° C. under 1 sun and can serve as a practical device for promoting water evaporation.

FIG. 16 (inset b) compares the temperature distribution under 5 sun between the MJF-printed porous plate and the tree array structure (a plurality of tree-like structures disposed on a MJF-printed porous plate). The surface temperature of the tree array structure increased with an increase in irradiation intensity. The surface temperature of the tree array structure was significantly higher than that of the MJF-printed plate under the same conditions, as shown in FIG. 17 (inset c), demonstrating that the tree-like surface topology has superior light absorption efficiency. A dense forest of the tree-like structures arranged on a surface of a MJF-printed porous plate (tree array structure) could enhance the absorption of light radiation, thereby facilitating the heating and evaporation of seawater at the interface, as shown in FIG. 17 (inset d). The gaps beneath the canopy of the tree-like structures can effectively block the dissipation of heat, allowing heat to accumulate at the bottom of the tree-like structures (e.g., between the tree-like structures and the MJF-printed porous plate) and raise the temperature at the exposed surfaces of the SSG, which is beneficial for achieving faster water evaporation.

Alternatively described, a SSG module may include an SSG plate (e.g., MJF-printed porous plate) and a tree-structured SSG (e.g., a plurality of tree-like structures), in which the SSG plate and the tree-structured SSG are integrally MJF-printed as a single MJF-printed article, and in which the both the SSG plate and the tree-structured SSG are made of the same porous material.

In some embodiments, the SSG module may be MJF-printed as a single article or as an integral article, in which the SSG module includes a water-facing portion and a light-facing portion. The water-facing portion may be configured to have a porous structure characterized by nano-scale or micro-scale pores or channels in the material. The light-facing portion may be configured to have a primary porous structure characterized by nano-scale or micro-scale pores or channels in the material of the branches and/or trunks, as well as a secondary porous structure defined by a network or interlacing branches and/or trunks and the spaces between the branches and/or trunks.

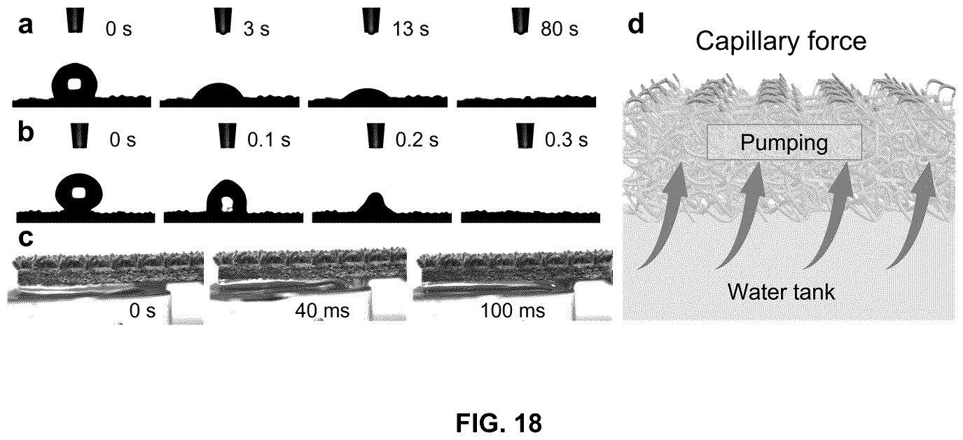

The tree-like structures on the MJF-printed porous plate have a negligible influence on the water affinity, as confirmed by water contact angle test and high speed camera (FIG. 18). Water droplets can permeate into the inner spaces of the tree-like structures in the same way water can permeate into the MJF-printed porous plate.

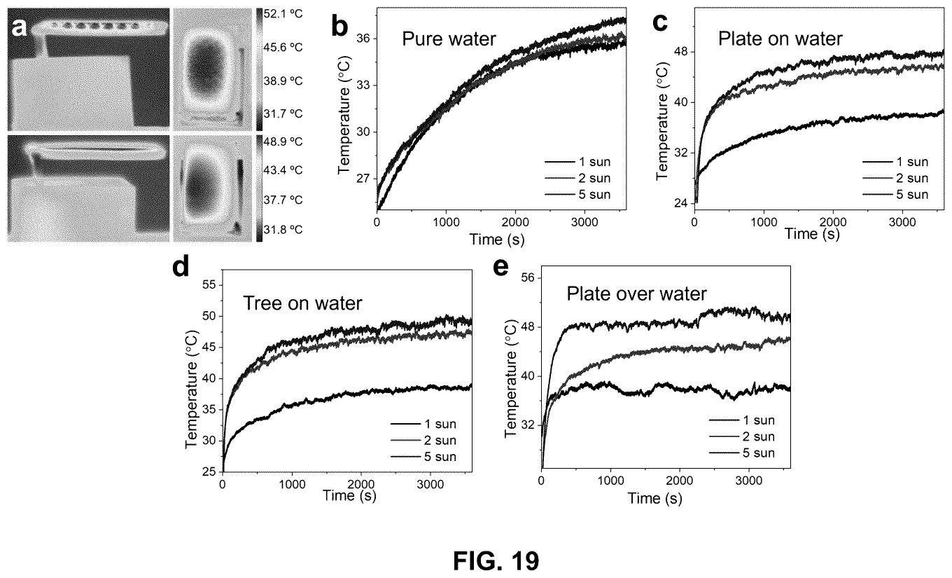

After water is absorbed, the temperature distribution difference between the SSG plate and the tree-structure SSG becomes more pronounced. In the case of the SSG plate, a high temperature zone only exists on the surface of the SSG plate. In the case of the tree-structured SSG, the high temperature zone extends deep into the tree-like structures, e.g., FIG. 14 (inset e) and FIG. 19 (inset a).

When subjected to the same light intensity, the tree-structured SSG can achieve a higher temperature than the SSG plate. Additionally, when placed above water, the temperature of the tree-like structures is higher than that of the SSG plate (FIG. 19, inset b to e). Considering the significantly larger specific surface area of tree-structured SSG, this feature will be beneficial for enhancing the evaporation rate.

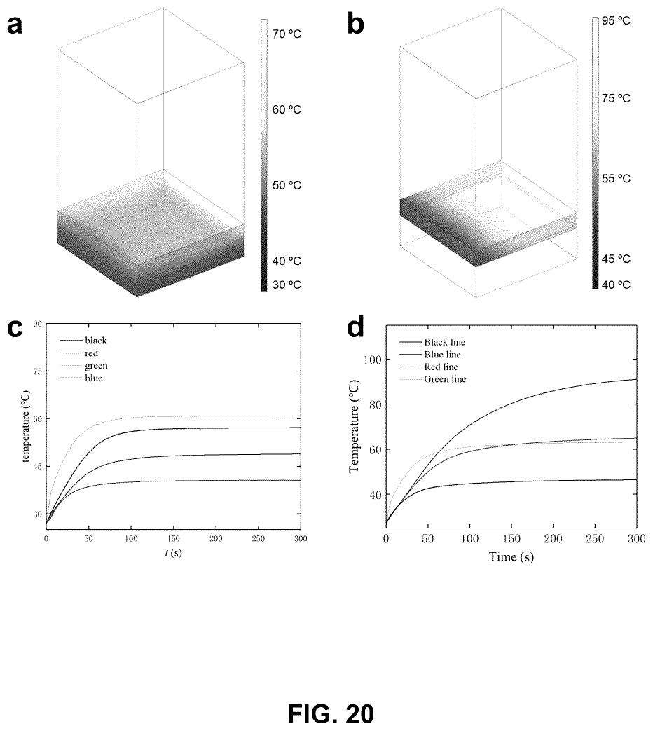

Tree-like structures allowed more heat consumption through increased SSG-air interface and minimized the energy dissipated to the materials underneath the surface of the MJF-printed porous plate, thus improving their energy efficiencies. To better understand the light-to-thermal energy conversion and water evaporation processes, the heat and moisture air transfer process in the generator system were simulated by a finite element model built in the commercial software COMSOL Multiphysics 6.0. The established model has the same dimensions as one unit of the printed samples and is subjected to normal incidence irradiation from the light in the solar simulator. Consistent with experimental results, simulation results showed that the use of the SSG plate and the tree-structured SSG proposed herein were found to improve the water temperature (FIG. 17 inset a, FIG. 17 inset b, and FIG. 20 insets a to c). The predicted temperature distribution of tree-like structure closely aligns with the experimental results, for the case when the tree-like structure is placed on water or above water. In particular, the simulation results for the case in which the tree-like structure is placed above water (e.g., positioned to be spaced apart from and elevated from the water, or placed so that the MJF-printed porous plate is not in direct physical contract with the water) are in good agreement with the experimental results (FIG. 20 inset d). This demonstrates a remarkable accuracy of the simulation method used.

An equilibrium surface temperature will be affected by surface microstructures owing to structural shadowing and changed light incident angles. The simulated outcomes and experimental results confirmed that the tree-like structure exhibits no detrimental impact on surface temperature beneath tree-like structure. At the same time, the tree-like structure promotes the accumulation of heat (FIG. 17 inset c). This property may be ascribed to the heat consumption caused by the water evaporation process. No water was on the top of tree-like structures but rather water accumulated beneath the tree-like structure (FIG. 17 inset d). Similar to transpiration of plants, the water that has been heated at the lower part of the tree-array structure would be continuously transported to an upper surface of the tree-like structure and escaped in the form of water vapor. The evaporation of water takes away a large amount of heat, generating a lower temperature on the surface of the tree-like structure while a lower part of the tree array structure (e.g., beneath the tree-like structure) has a higher temperature. Overall, the simulation results and the experimental results show that the porous MJF-printed article can utilize capillary action to enhance water absorption and the sustainability of water evaporation.

### Water Evaporation Performance

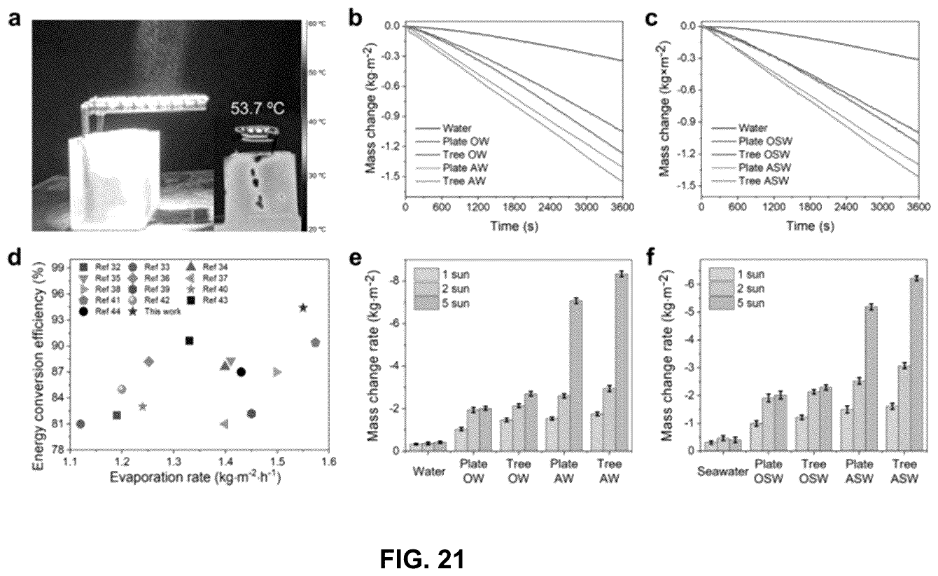

It was found that the MJF-printed porous article can have many practical applications, including but not limited to the making of SSGs with shapes or dimensional configurations that would be difficult or impossible to manufacture without MJF printing. In particular, it was found that SSGs shaped with one or more columns can generate a large amount of vapor in a very short time (e.g., shorter than 10 seconds). The experimental set-up is shown in FIG. 21 (inset a). As shown in the side view infrared image, the solar thermal energy was efficiently utilized as the heat concentrated on the surfaces of the SSGs without diffusing downwards through the columns or the trunks.

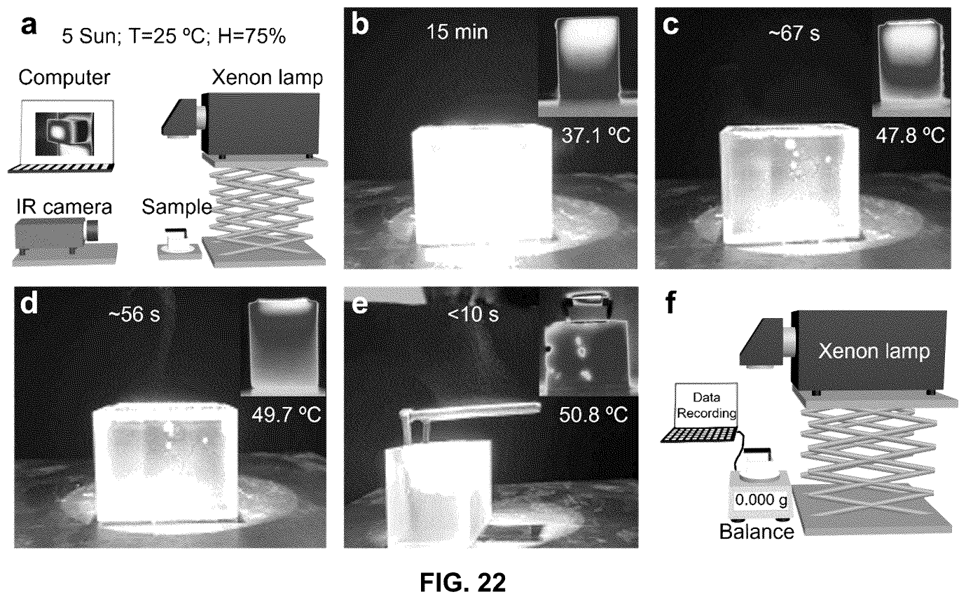

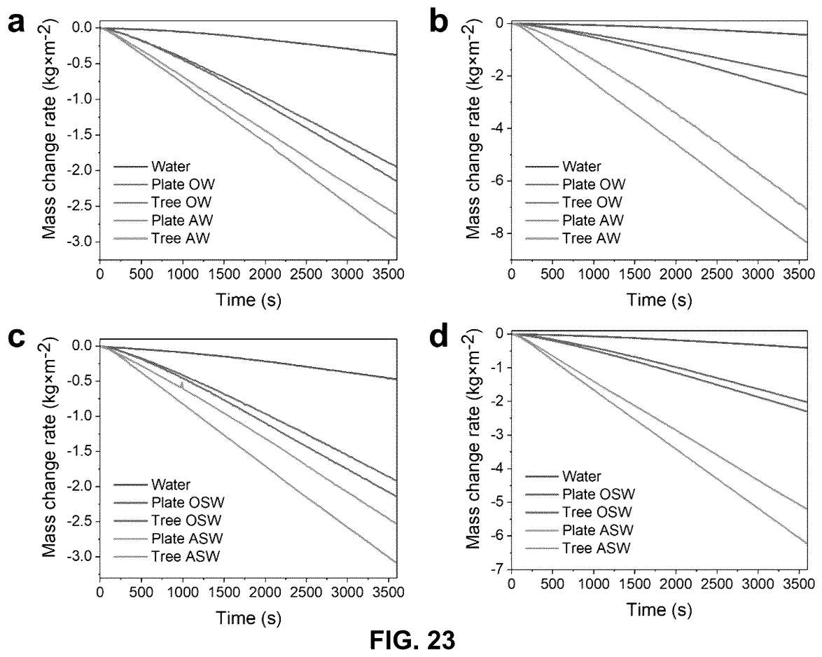

Compared with SSG plate, the tree-structured SSG can produce more vapor, indicating that the tree-structured SSG can be capable of a higher seawater evaporation rate (FIG. 22, insets a to e). The water evaporation tests were performed under different solar irradiation intensities (1 sun, 2 sun, and 5 sun, respectively) with water and seawater (FIG. 22 inset f). FIG. 21 (insets b and c) and FIG. 23 show the superiority of the tree-structured SSG in promoting water evaporation. The detailed data can be seen in Table 3.

TABLE 3
Data on evaporation mass in 1 hour under different irradiation intensities.

| Solar irradiation intensity | | | | |
|---|---|---|---|---|
| (kW · m⁻²) | | 1 | 2 | 5 |
| Mass | Water | −0.34 ± −0.04 | −0.37 ± −0.07 | −0.43 ± −0.05 |
| change | SSG plate on water | −1.05 ± −0.08 | −1.94 ± −0.12 | −2.02 ± −0.09 |
| (kg · m⁻²) | Tree-structured | −1.26 ± −0.09 | −2.14 ± −0.09 | −2.70 ± −0.11 |
| | SSG on water | | | |
| | SSG plate above | −1.41 ± −0.07 | −2.60 ± −0.1 | −7.07 ± −0.13 |
| | water | | | |
| | Tree-structured | −1.55 ± −0.09 | −2.95 ± −0.14 | −8.33 ± −0.14 |
| | SSG above water | | | |
| | Seawater | −0.31 ± −0.06 | −0.47 ± −0.09 | −0.41 ± −0.1 |
| | SSG plate on | −0.99 ± −0.1 | −1.91 ± −0.14 | −2.02 ± −0.14 |
| | seawater | | | |
| | Tree-structured | −1.10 ± −0.08 | −2.14 ± −0.08 | −2.3 ± −0.098 |
| | SSG on seawater | | | |
| | SSG plate above | −1.29 ± −0.13 | −2.53 ± −0.12 | −5.19 ± −0.109 |
| | seawater | | | |
| | Tree-structured | −1.41 ± −0.11 | −3.08 ± −0.105 | −6.22 ± −0.09 |
| | SSG above | | | |
| | seawater | | | |

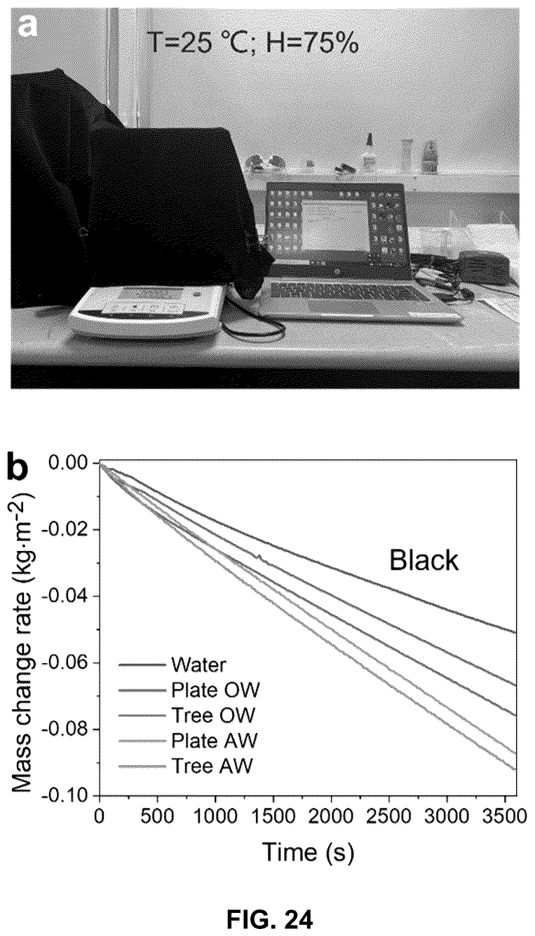

The water evaporation rate E values of different SSG configurations are arranged in order: SSG plate<tree-structured SSG<SSG plate above water<tree-structured SSG above water. The tree-like structure improves water evaporation efficiency, as evidenced by the higher rate of water evaporation compared to the SSG plate under dark conditions (FIG. 24). This can be attributed to the increased contact area between water and air resulting from the tree-like structure, which enhances the evaporation of water.

Placing the SSG plate and/or the tree-structured SSG above the water leads to a significant increase in the E value compared to placing the same article on the water. This outcome aligns with anticipated results, primarily because the separation of the SSG from water reduces heat dissipation, enhancing the efficiency of photothermal energy utilization. Under 1 sun irradiation, the highest E value was obtained by tree-structured SSGs placed above water, as high as 1.55 kg m⁻²·h⁻¹. In contrast to this, the value of E for seawater under 1 sun irradiation was 1.41 kg m⁻²·h⁻¹. Overall, the water evaporation rate of water was slightly higher than that of seawater, due to the high concentration of ionic salts in seawater requiring more heat for evaporation. With the increasing irradiation intensity, the evaporation rate increased sharply.

One or more columns may be made by MJF printing using a similar material as the SSG plate and/or the tree-structured SSG. The one or more columns may be configured as one or more supporting structure or “leg” partially dispose in a body of water, with the one or more column supporting the SSG plate and/or the tree-structure SSG above water or spaced apart from the body of water. The one or more columns prevents a loss of heat from the SSG plate to the body of water (e.g., the sea) and yet provides enough water for transpiration on the surface of SSGs, even at 5 sun.

The energy conversion efficiency g of printed porous SSGs can be calculated by Equation (4):

$$η = {mh}_{Lv} / {C}_{opt} {q}_{i} \qquad ( 4 )$$

where m denotes the evaporation rate (the rate of water evaporation under the dark conditions is subtracted), qᵢ is the nominal solar irradiation of 1 kW m⁻², and Copt is the multiple of 1 sun. h_{Lv} denotes total enthalpy of liquid-vapor phase change (including sensible heat and phase-change enthalpy), which can be calculated as

$${h}_{Lv} = λ + C Δ T \qquad ( 5 )$$

where λ is the heat of water vaporization (varying from 2441.7 kJ·kg⁻¹ at 25° C. to 2265.4 kJ·kg⁻¹ at 100° C.), C is specific heat capacity of water, 4.182 kJ·kg⁻¹·° C.·⁻¹, and ΔT denotes the temperature increase in the water. The conversion efficiencies of the SSGs under 1 sun were 67.2%, 81.1%, 85.2%, and 94.4% for SSG plate on water, tree-structured SSG on water, SSG plate above water, and tree-structured SSG above water, respectively.

These results not only compare favorably to reported polymeric SSGs but also outperform the majority of data (e.g., FIG. 21 inset d and Table 4).

TABLE 4
Comparison of the structure, preparation method, and water
evaporation performance of several reported polymeric SSGs

| | | Preparation | Using | m | η |
|---|---|---|---|---|---|
| Polymer | Structure | Method | mode | (1 kW m⁻² · h⁻¹) | (%) |
| Oligoanilines | NaCl template | Polymerization | Bulk | 1.1902 | 82.0 |
| | foam | | | | |
| Cellulose | Aerogel | Freeze dry | Bulk | 1.12 | 81 |
| Polystyrene | Foam | Freeze dry | Bulk | 1.3986 | 87.6 |
| Polypyrrole | Foam | Freeze dry | Bulk | 1.41 | 88.3 |
| (PPy) | | | | | |
| Polyolefin | PEO-templated | Melt blending | Bulk | 1.252 | 88.2 |
| elastomer | foam | | | | |
| Microporous | Aerogel | Polymerization | Bulk | 1.399 | 81 |
| polymer | | | | | |
| PPy-sodium | Foam | Freeze dry | Bulk | 1.498 | 87 |
| alginate | | | | | |
| Poly(vinyl | Hydrogel | Freeze-and-thaw | Bulk | 1.45 | 82.2 |
| alcohol) | | | | | |
| Nylon 6 | Film | Electrospinning | Bulk | 1.24 | 83 |
| Melamine | Foam | Deposition | Bulk | 1.574 | 90.4 |
| foam | | | | | |
| Attapulgite | Aerogel | Freeze dry | Bulk | 1.2 | 85 |
| polymer | | | | | |
| Polyurethane | Foam | Deposition | Bulk | 1.43 | 87 |
| sponge | | | | | |
| Cellulose / | Hydrogel | Conventional 3D | Grid | 1.33 | 90.6 |
| alginate | | printing | structure | | |
| Porous PA12 | Na₂Co₃ Template | MJF printing of | Tree-like | 1.55 | 94.4 |
| | foam | the present | structure | | |
| | | disclosure | | | |

The SSGs (or evaporators) made using the method proposed herein demonstrated significant improvements in the evaporation rate and energy utilization. The hierarchical porous tree-like structure of the proposed SSGs provides a light-trapping effect, while the C@Fe₃O₄ hybrids broaden the light absorption bandwidth and enhance the conversion efficiency of light to heat. Moreover, the evaporation interface is fully detached or spaced apart from the water, enabling effective localization of the converted heat within the porous structure. This results in a high efficiency of photothermal-driven water-to-steam generation. As shown in FIG. 21 (inset e and inset f), as the intensity of light radiation increases, the rate of water evaporation also increases, indicating that the proposed SSGs maintain good photothermal properties under strong light intensity.

### Self-Cleaning

During seawater desalination processes, the proposed MJF-printed porous article demonstrated effective self-cleaning performance against salt accumulation.

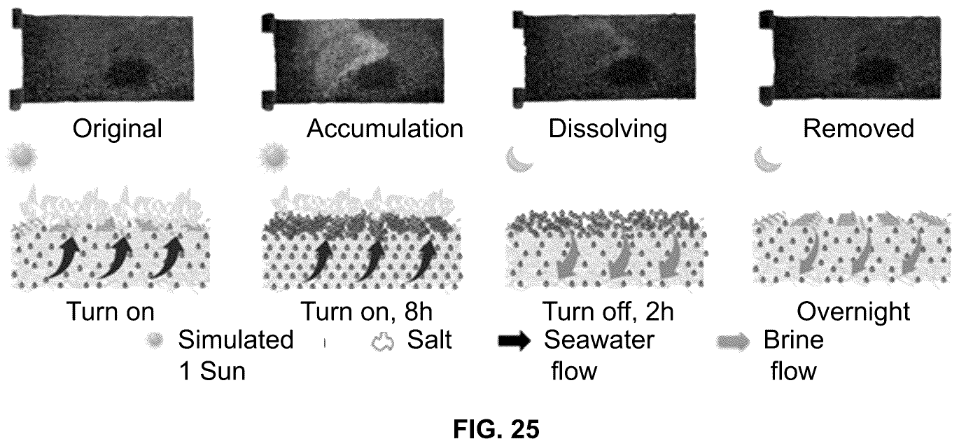

Following 8 hours of uninterrupted exposure to 1 sun illumination, the surface of the proposed SSGs (being prototypes of one embodiment of the proposed MJF-printed porous article) exhibited the accumulation of white salts resulting from the evaporation of seawater (FIG. 25). Upon cessation of light exposure, the amount of salt on the surface of the SSG surface gradually diminished until there remains negligible or no salt on the surface of the SSG. This phenomenon indicates that the SSG printed by MJF has the function of salt self-cleaning. This phenomenon can be attributed to the water flow propelled by capillary forces as well as the concentration difference between a region of higher salt concentration (on the SSG surface) and the water in the container.

As the accumulated salt dissolves in the surface water, a high concentration brine may be formed. Salt ions on the SSG surface are then transferred to a region of lower salt concentration through diffusion until a concentration equilibrium is reached. During this process, the accumulated salt on the surface is gradually reduced until most if not all of the salt deposits on the surface of the SSG is dissolved.

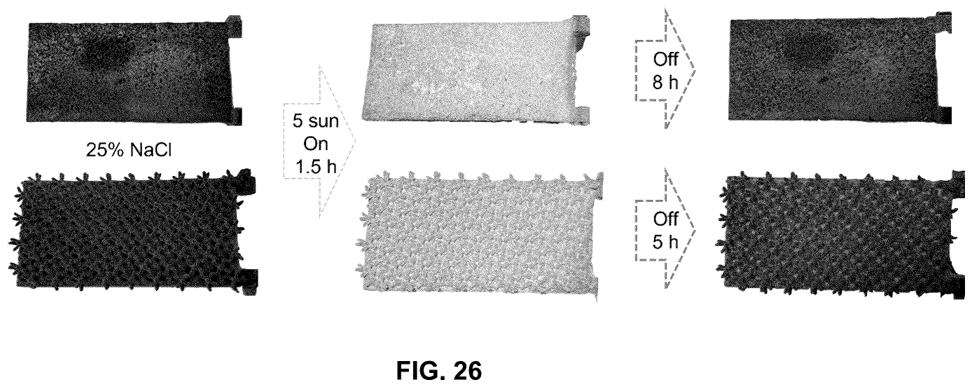

To further verify the stability of the self-cleaning property, an experiment was conducted in which the solar intensity was increased to 5 sun and a high-concentration NaCl solution (25 wt. %) was used. Evaporation of the salt solution was expected to create more salt accumulation on the surface of the SSG (FIG. 26). The surface of SSGs turned completely white after 1.5 hours of irradiation. After a certain period of time following the removal of the lamp, it was observed that most if not all of the salt on the surface of the SSG has been removed. It would appear that the tree-like structure of the SSG enhances this self-cleaning property, facilitating the removal of surface salt. This result indicates that the proposed MJF-printed SSGs having the material composition disclosed herein have a good salt self-cleaning ability.

This is of great significance for the application of SSGs. With conventional SSGs, the accumulated salts hinder the water transfer function and negatively impact the photothermal performance of SSGs, reducing the desalination efficiency. With a self-cleaning property, the proposed SSGs can undergo a cleaning process at night to clean away the salt accumulated during the day without compromising the daytime photothermal performance or seawater evaporation efficiency. This results in a sustainable desalination process.

### Sustainable Desalination

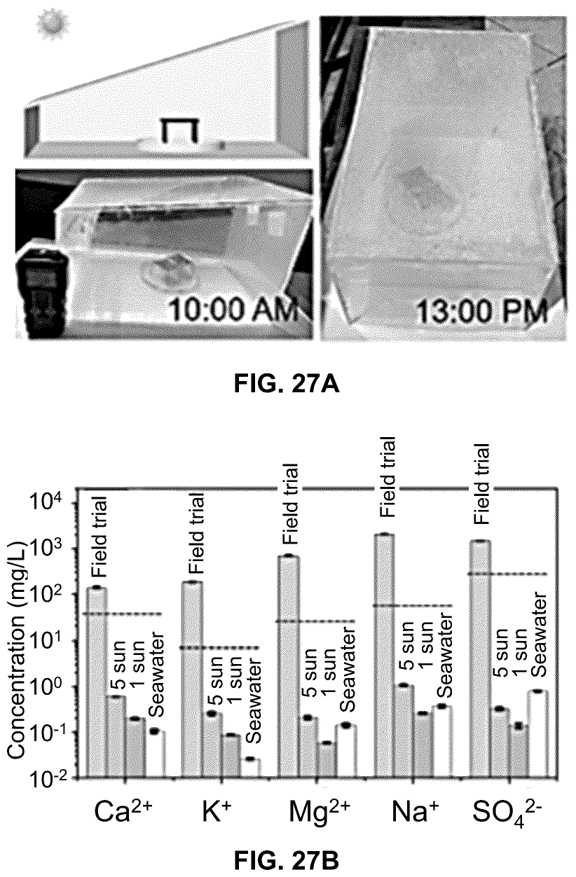

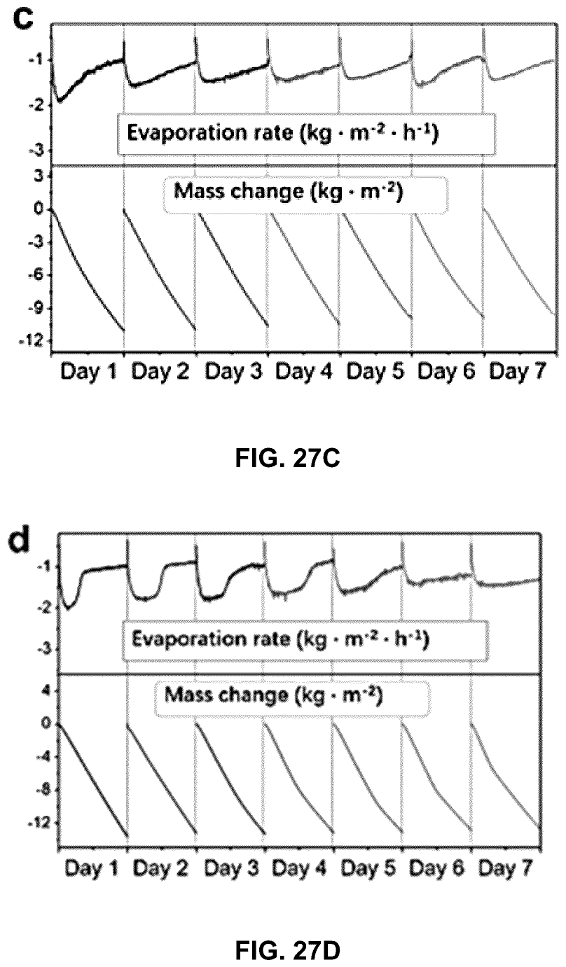

To assess the practical applicability of the proposed MJF-printed material (proposed SSG material) for outdoor desalination, a solar desalination device was designed and fabricated (FIG. 27A). The solar desalination device had dimensions of 20×40×20 cm³ and was constructed using a 3 mm thick transparent polymethyl methacrylate plate. The proposed SSG was placed into the solar desalination device. In operation, steam generated by the proposed SSG condensed on a top plate of the solar desalination device. The condensed water was collected in a container at the bottom of the solar desalination device. The proposed SSG material used in this desalination device had an area of 50 cm². When the container was placed outdoors at 10:00 a.m. (1100 W m²) and retrieved at 1:00 p.m., it was observed that the previously transparent walls of the container were covered with water droplets after only 3 hours. This demonstrated the ability of the proposed SSG to serve as a desalinator.

The ion concentration of the collected water was analyzed to verify whether it met the standard for direct drinking. Compared with the high concentrations of ions in seawater, the content of anions and cations in the collected water decreased by over 99.99%, meeting the World Health Organization (WHO) standard for drinking water (FIG. 27B). Even the water collected under high solar irradiation intensity can meet the standards for safe consumption, confirming the well-performance of sustainable seawater desalination. In other words, the desalinated water is considered sufficiently clean for daily use.

Table 5A and Table 5B compare other features, such as the manufacturing scalability and environmental impact. It can be seen that the proposed SSG compares favorably relative to other types of SSG or photothermal materials.

TABLE 5A

| | | | | Sample size | Surface |
|---|---|---|---|---|---|
| Substrate | Filler | Technique | Mold | (cm) | structure |
| rGO | — | Freeze-dry | Yes | 18 × 18 | No |
| Cellulose paper | GO/CNTs | Spray | Yes | 7.2 × 6.0 | Origami |
| PU foam | TA@APTES@Fe³⁺ | Immersion | Yes | 28 × 22 | No |
| PVA/PVP | Attapulgite/poly | Freeze-dry | Yes | 3.4 (D) | No |
| | acrylamide | | | | |
| Ethyl cellulose | Annealed carbon | Casting | Yes | 0.03 m² | No |
| Acrylic/epoxy resin | Graphene powder | SLA | No | 10 (D) | Aligned |
| | | | | | pores |
| Acrylic ester resin | Carbon nanofiber | DLP | No | 0.012 m² | Cavity |
| Cellulose acetate | Carbon particles | DIW | No | 1.5 × 1.5 | Holes |
| Cellulose/alginate | Carbon black | DIW | No | 5 × 4 | No |
| Silica | Graphene | DIW | No | 3 × 2 | No |
| PA12 powder | C@Fe₃O₄ | MJF of the | No | 24.7 × 24.7 | Tree-like |
| | | present | | | structure |
| | | disclosure | | | |

NB: “Sample size” refers to the largest size reported.
“(D)” denotes diameter.

TABLE 5B

| | | Duration of | |
|---|---|---|---|
| | | preparation | |
| Substrate | Filler | (day) | Recyclability |
| rGO | — | >3 | No |
| Cellulose paper | GO/CNTs | >1 | No |
| PU foam | TA@APTES@Fe³⁺ | >1.5 | No |
| PVA/PVP | Attapulgite/poly | >4 | Yes |
| | acrylamide | | |
| Ethyl cellulose | Annealed carbon | ~1 | No |
| Acrylic/epoxy resin | Graphene powder | ~1 | No |
| Acrylic ester resin | Carbon nanofiber | >1 | No |
| Cellulose acetate | Carbon particles | >1 | Yes |
| Cellulose/alginate | Carbon black | ~1 | Yes |
| Silica | Graphene | >2 | No |
| PA12 powder | C@Fe₃O₄ | ~1 | Yes |

“Recyclability” in Table 5B refers to the potential for recycling or reuse of the substrate material. As the proposed SSG could be MJF-printed as an integral article using the same material, it presents opportunities for recycling and material reuse. For example, the SSGs could be ground into a powder form and refabricated through MJF. This potential recycling, if realized, would not only mitigate the environmental impact by minimizing discards and by reducing raw materials needed.

### Durability Test

To assess the durability of the SSG apparatus and evaluate the impact of the tree-like structures on the performance of the SSG and the stability of the seawater desalination process, a one-week test was conducted under simulated sunlight for 9 hours per day. The results of this test, comparing the SSG plate with the tree-like SSG structure, are presented in FIG. 27A and FIG. 27D, respectively. During the one-week test, no significant change was observed in the seawater desalination capacity and rate for the proposed SSG with the tree-structured SSG. In contrast, the desalination capacity of the SSG plate dropped remarkably by 10%.

Overall, the tree-structured SSG layer not only significantly enhanced the seawater desalination capacity, resulting in more substantial mass loss, but also notably improved the durability of the SSG.

The seawater desalination efficiency of both SSG configurations initially increased and then reached a stable level. This phenomenon could be attributed to the accumulation of halides on the sample surface after prolonged exposure to light, which caused salt precipitation and blocked the capillary action, resulting in a decrease in capillary force and hindering the rapid supply of seawater. Nonetheless, thanks to the self-cleaning effect, the accumulated salt in the capillary channels could be removed, minimizing impact on subsequent usage. This indicates that the proposed SSG is capable of operating for extended periods. Specific data regarding the mass loss of seawater and the water evaporation rate can be found in Table 6.

TABLE 6
Data collected from one-week seawater evaporation
tests of SSG plate and tree-structured SSG.

| | Mass change (kW · m⁻²) | | Evaporation rate (kW · m⁻² · h⁻¹) | |
|---|---|---|---|---|
| | | Tree-structured | | Tree-structured |
| Day | SSG plate | SSG | SSG plate | SSG |
| 1 | −11.04 ± 0.19 | −13.67 ± 0.12 | −1.76 ± 0.12 | −1.97 ± 0.19 |
| 2 | −10.96 ± 0.51 | −13.21 ± 0.23 | −1.59 ± 0.23 | −1.80 ± 0.51 |
| 3 | −10.60 ± 0.38 | −13.32 ± 0.19 | −1.51 ± 0.19 | −1.76 ± 0.38 |
| 4 | −10.53 ± 0.34 | −13.19 ± 0.17 | −1.45 ± 0.3 | −1.70 ± 0.34 |
| 5 | −9.91 ± 0.54 | −13.08 ± 0.24 | −1.43 ± 0.24 | −1.68 ± 0.54 |
| 6 | −9.88 ± 0.4 | −12.86 ± 0.3 | −1.38 ± 0.24 | −1.52 ± 0.4 |
| 7 | −9.56 ± 0.45 | −12.69 ± 0.24 | −1.35 ± 0.17 | −1.49 ± 0.45 |

### Tests on Large-Scale SSGs

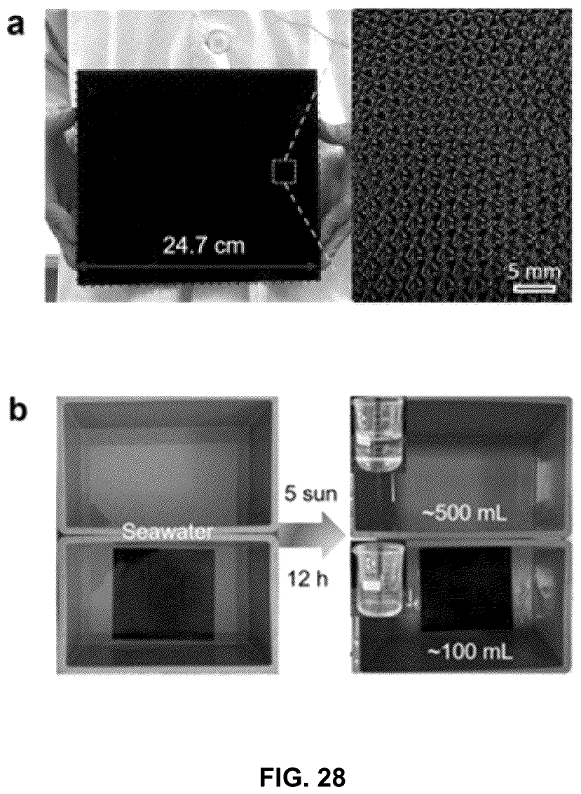

To assess the commercial applicability of the powder formulation proposed in this study, the MJF 5200 printing technology was employed to fabricate tree-structured SSGs using a fusing agent commercially available from the HP company. The fabrication process successfully produced large-area SSGs with intricate structures, thus confirming the substantial potential for practical application of the SSGs (FIG. 28, inset a).

The SSGs demonstrated promising performance in seawater desalination, as evidenced by the results obtained (FIG. 28, inset b). Specifically, when the tree-structured SSGs were utilized, one liter of seawater was entirely evaporated, whereas in the absence of the SSGs, approximately 500 ml of water remained unconsumed.

In one aspect, the above discloses a photothermal ink, composed of water, surfactant, and MOFs-derived carbon encapsulated the Fe₃O₄ (the C@Fe₃O₄) hybrid, that was synthesized and applied as the fusing agent for MJF printing. Porous SSGs with complex topologies were designed, printed, and applied for water evaporation and seawater desalination. Thermostable and low-toxicity sodium carbonate (Na₂CO₃) was applied as a porogen for printing porous polyamide 12 (PA12)-based parts with capillary structure. The characterization of the structures and morphologies of both the synthesized ink and printed SSGs was performed to optimize the material formulations. Based on the above-mentioned, a series of MJF-printed porous SSGs with special surface structures were prepared, which exhibited excellent photothermal performance and salt self-cleaning properties. Embodiments of the present disclosure offer a fast and easy preparation method for the fabrication of three-dimensional SSGs with complex structures and high efficiency and has the potential to expand the application fields of MJF technology.

In the examples described, MOFs-derived C@Fe₃O₄ hybrids were developed and used as the fusing agent for MJF printing to create SSGs with complex surface topologies, merely to aid understanding, and not to preclude the making of other types of MOF-based materials or hybrids. The photothermal properties, water evaporation rate, and salt self-cleaning ability of the material were assessed. The outcomes demonstrated that MOF-derived materials or metal-organic hybrids, such as C@Fe₃O₄ nanoparticles, display remarkable photothermal performance and can be employed in conjunction with MJF printing to manufacture robust and reliable SSGs. A range of material formulation was developed and experimentally verified to be useful for forming MJF-printed articles incorporating a capillary structure. It is conceived that such material formulations have a wide range of practical applications, including but not limited to the making of SSGs possessing superior hydrophilic properties.

The combination of carbon-based nanomaterials and metal oxide nanoparticles has been scientifically validated as an effective approach for producing high-efficiency solar steam generation devices. This approach combines the advantageous properties of carbon-based materials, including low cost, reusability, and a broad solar absorption spectrum. Nontoxic metal oxides, on the other hand, offer high conversion efficiency and chemical stability to the SSG devices. Metal-organic frameworks (MOFs)-derived carbons, metal oxides, and carbon-encapsulated metal oxides are found to be useful for the present purpose and can advantageously be relatively easy to prepare, is available in diverse compositions, and can be precisely controlled in terms of physicochemical properties. Without being bound by theory, it is envisioned that the high surface area and porosity of MOFs provide a good template for the synthesis of carbon-encapsulated metal oxides with a highly ordered hierarchical structure, which can enhance sunlight absorption efficiency, high solar-to-steam conversion efficiency, and steam generation rate.

Prototypes of SSGs made using the proposed MJF printing materials were fabricated and tested. The water evaporation experiments revealed that the tree-structured SSGs considerably enhance the water evaporation rate, for both fresh and seawater, rendering them exceptionally well-suited for desalination applications. Furthermore, the unique porous structure of the SSGs generates capillary forces that can eliminate salt accumulation, resulting in exceptional self-cleaning performance. This enhances the sustainability of seawater desalination processes. The long-term seawater desalination tests showed that the SSGs of the present disclosure can effectively produce potable water that meets WHO requirements. Merely to aid understanding and not to be limiting, the present disclosure describes the proposed technical solution from an interdisciplinary approach, incorporating aspects of nanomaterials science, advanced additive manufacturing technologies, and surface structural design, with practical considerations in the context of the practical implementation of efficient SSGs.

### Applications

Freshwater scarcity is a pressing issue worldwide, and solar steam generators (SSGs) have emerged as a promising device for seawater desalination, harnessing renewable solar energy to facilitate sustainable water evaporation. The facile fabrication approach for SSG with complex topologies to achieve high water evaporation efficiency remains a challenge. Water scarcity is a significant problem in areas with increasing water consumption, caused by urbanization and the increasing demand for freshwater in households. One solution to this problem is the desalination of seawater, which can be achieved through the application of SSGs or solar-driven water evaporators. While the performance of SSGs depends heavily upon weather conditions and geographical location, their potential remains promising in numerous global regions, such as Singapore, Greece, and Saudi Arabia. There are various methods to increase the rate of water evaporation: raising the temperature of water, increasing the surface area of water, and accelerating surface air flow. SSGs use non-polluting solar energy to improve the efficiency of seawater desalination mainly through the first two methods.

There is therefore an ongoing challenge to create SSGs with enhanced steam generation efficiency, high sunlight absorptivity, and large specific surface area. The feasibility of mass production of SSGs with complicated structures is just one of many challenges faced in the development of practical SSGs for seawater desalination. Researchers are exploring the use of substances such as carbon-based nanomaterials and metallic nanomaterials (gold and metal oxides) with high absorbance in sunlight spectrum. However, the use of nanomaterials in powder form in seawater evaporation must be approached with caution due to the complex recycling process and potential secondary pollution on water bodies. In addition, the commonly used subtractive manufacturing process for fabricating structures with large surface areas is relatively complicated, hindering the development and practical implementation of advanced SSGs.

The MJF-printed porous articles proposed herein provide a way to address the much felt needs, including but not limited to the making of SSGs for effective utilization of solar energy and converted heat.

In one aspect, according to various embodiments of the present disclosure, a method includes: selectively depositing a photothermal ink in a powder bed, the powder bed containing a powder mixture, the powder mixture including a polymer powder and a porogen powder; subjecting the powder bed to an infrared radiation to form a composite article; and removing the porogen from the composite article to form a porous article, the porous article having a plurality of pores distributed therein, in which the photothermal ink includes a fusing agent, the photothermal ink being characterized by a photothermal response to the infrared radiation enabling the fusing agent to fuse with the polymer.

The method above, in which the removing of the porogen may include subjecting the composite article to an ultrasonic water bath.

The method above, in which the photothermal ink may include a dispersion of the fusing agent in a solution.

The powder mixture may be characterized by a volume ratio of the porogen to the polymer in a range from 20:80 to 40:60.

The powder mixture may be characterized by a volume ratio of the porogen to the polymer of 30:70.

The powder mixture may be characterized by a volume ratio of the porogen to the polymer of 20:80.

The method may further include heating a mixture of iron (III) chloride hexahydrate (FeCl₃·6H₂O) with terephthalic acid in a mole ratio of 2:1 in a dimethylformamide solution to form an intermediate mixture, the intermediate mixture having a quantity of a precipitate; and annealing the precipitate to obtain a carbon encapsulated iron oxide, in which the photothermal ink is a dispersion of the carbon encapsulated iron oxide in a polyvinylpyrrolidone solution.

The powder mixture may be a mixture of a polyamide 12 (PA12) and sodium carbonate.

The fusing agent may include any one or more metal-organic hybrid selected from the group consisting of metal-organic framework (MOF) derivatives, metal oxide loaded carbon materials, and biomass materials.

The fusing agent may include any one or more metal-organic hybrid selected from the group consisting of a zeolitic imidazolate, a Material Institute of Lavoisier MOF, a University of Oslo MOF, a Hong Kong University of Science and Technology MOF, and a porous coordination network.

The fusing agent may include any one or more selected from the group consisting of carbon nanotubes, graphene, carbon black, activated carbon, and carbon fibers.

The fusing agent may include any one or more selected from the group consisting of melanin, squid ink, and polydopamine.

The polymer may include any one or more selected from the group consisting of synthetic polymer and thermoplastic.

The polymer may include any one or more selected from the group consisting of polyamide, polyvinyl alcohol, polylactic acid, polyethylene terephthalate glycol, thermoplastic polyurethane, high impact polystyrene, acrylonitrile butadiene styrene, and polypropylene.

The porogen may include any one or more selected from the group consisting of potassium nitrate, potassium sulfate, sodium sulfate, calcium chloride, and sodium carbonate.

The porogen may include any one or more selected from the group consisting of glucose, sodium alginate, guar gum, gelatin, chitosan, and pectin.

In another aspect, an article made according to any of the embodiments described above, in which the plurality of pores are configured to enable capillary action in the plurality of pores.

The article in which the porous composite is characterized by a porosity in a range from 20% to 40% by volume.

The article may include: a plate; and a plurality of tree-like structures, the plate, and the plurality of tree-like structures of the porous composite, the plurality of tree-like structures being disposed on the plate.

In yet another aspect, according to various embodiments of the present disclosure, the method includes selectively depositing a photothermal ink in a powder bed, the powder bed containing a powder mixture, the powder mixture including a polymer powder and a porogen powder; subjecting the powder bed to an infrared radiation to form one or more composite articles; and removing the porogen from the one or more composite article to form a corresponding one or more porous article, the one or more porous article having a plurality of pores distributed therein, in which the photothermal ink includes a fusing agent, the photothermal ink being characterized by a photothermal response to the infrared radiation enabling the fusing agent to fuse with the polymer; and in which the one or more porous article forms a solar steam generator, the solar steam generator including: a plate, one or more column, and a plurality of tree-like structures; and in which the one or more column extends from a first side of the plate; and in which the plurality of tree-like structures are disposed on a second side of the plate opposite the first side.

All examples described herein, whether of apparatus, methods, materials, or products, are presented for the purpose of illustration and to aid understanding and are not intended to be limiting or exhaustive. Modifications may be made by one of ordinary skill in the art without departing from the scope of the claimed invention.

1. A method comprising:
selectively depositing a photothermal ink in a powder bed, the powder bed containing a powder mixture, the powder mixture including a polymer powder and a porogen powder;
subjecting the powder bed to an infrared radiation to form a composite article; and
removing the porogen from the composite article to form a porous article, the porous article having a plurality of pores distributed therein,
wherein the photothermal ink comprises a fusing agent, the photothermal ink being characterized by a photothermal response to the infrared radiation enabling the fusing agent to fuse with the polymer.

2. The method as recited in claim 1, wherein the removing of the porogen comprises subjecting the composite article to an ultrasonic water bath.

3. The method as recited in claim 1, wherein the photothermal ink comprises a dispersion of the fusing agent in a solution.

4. The method as recited in claim 3, wherein the powder mixture is characterized by a volume ratio of the porogen to the polymer in a range from 20:80 to 40:60.

5. The method as recited in claim 3, wherein the powder mixture is characterized by a volume ratio of the porogen to the polymer of 30:70.

6. The method as recited in claim 3, wherein the powder mixture is characterized by a volume ratio of the porogen to the polymer of 20:80.

7. The method as recited in claim 1, further comprising:
heating a mixture of iron (III) chloride hexahydrate (FeCl₃·6H₂O) with terephthalic acid in a mole ratio of 2:1 in a dimethylformamide solution to form an intermediate mixture, the intermediate mixture having a quantity of a precipitate; and
annealing the precipitate to obtain a carbon encapsulated iron oxide, wherein the photothermal ink is a dispersion of the carbon encapsulated iron oxide in a polyvinylpyrrolidone solution.

8. The method as recited in claim 7, wherein the powder mixture is a mixture of a polyamide 12 (PA12) and sodium carbonate.

9. The method as recited in claim 3, wherein the fusing agent comprises any one or more metal-organic hybrid selected from the group consisting of metal-organic framework (MOF) derivatives, metal oxide loaded carbon materials, and biomass materials.

10. The method as recited in claim 9, wherein the fusing agent comprises any one or more metal-organic hybrid selected from the group consisting of a zeolitic imidazolate, a Material Institute of Lavoisier MOF, a University of Oslo MOF, a Hong Kong University of Science and Technology MOF, and a porous coordination network.

11. The method as recited in claim 9, wherein the fusing agent comprises any one or more selected from the group consisting of carbon nanotubes, graphene, carbon black, activated carbon, and carbon fibers.

12. The method as recited in claim 9, wherein the fusing agent comprises any one or more selected from the group consisting of melanin, squid ink, and polydopamine.

13. The method as recited in claim 9, wherein the polymer comprises any one or more selected from the group consisting of synthetic polymer and thermoplastic.

14. The method as recited in claim 9, wherein the polymer comprises any one or more selected from the group consisting of polyamide, polyvinyl alcohol, polylactic acid, polyethylene terephthalate glycol, thermoplastic polyurethane, high impact polystyrene, acrylonitrile butadiene styrene, and polypropylene.

15. The method as recited in claim 9, wherein the porogen comprises any one or more selected from the group consisting of potassium nitrate, potassium sulfate, sodium sulfate, calcium chloride, and sodium carbonate.

16. The method as recited in claim 3, wherein the porogen comprises any one or more selected from the group consisting of glucose, sodium alginate, guar gum, gelatin, chitosan, and pectin.

17. An article made according to the method as recited in claim 1, wherein the plurality of pores are configured to enable capillary action in the plurality of pores.

18. The article as recited in claim 17, wherein the porous composite is characterized by a porosity in a range from 20% to 40% by volume.

19. The article as recited in claim 17, wherein the article comprises:
a plate; and
a plurality of tree-like structures, the plate, and the plurality of tree-like structures of the porous composite, the plurality of tree-like structures being disposed on the plate.

20. A method comprising:
selectively depositing a photothermal ink in a powder bed, the powder bed containing a powder mixture, the powder mixture including a polymer powder and a porogen powder;
subjecting the powder bed to an infrared radiation to form one or more composite articles; and
removing the porogen from the one or more composite article to form a corresponding one or more porous article, the one or more porous article having a plurality of pores distributed therein,
wherein the photothermal ink comprises a fusing agent, the photothermal ink being characterized by a photothermal response to the infrared radiation enabling the fusing agent to fuse with the polymer;
and wherein the one or more porous article forms a solar steam generator, the solar steam generator including: a plate, one or more column, and a plurality of tree-like structures;
and wherein the one or more columns extend from a first side of the plate;
and wherein the plurality of tree-like structures are disposed on a second side of the plate opposite the first side.
